(19) United States
(12) Patent Application Publication
(10) Pub. No.: US 2026/0067887 A1
(43) Pub. Date: Mar. 5, 2026

(54) TRANSMISSION INFORMATION DETERMINING METHOD, CONFIGURATION INFORMATION SENDING METHOD, TERMINAL, AND DEVICE

(71) Applicant: VIVO MOBILE COMMUNICATION CO., LTD., Dongguan (CN)

(72) Inventor: Na LI, Dongguan (CN)

(73) Assignee: VIVO MOBILE COMMUNICATION CO., LTD., Dongguan (CN)

(21) Appl. No.: 19/386,330

(22) Filed: Nov. 12, 2025

Related U.S. Application Data
(63) Continuation of application No. PCT/CN2024/091302, filed on May 7, 2024.

(30) Foreign Application Priority Data
May 12, 2023 (CN) 202310536774.5

(51) Int. Cl. H04W 72/1268; H04W 72/542

(52) U.S. Cl. CPC H04W 72/1268; H04W 72/542

(57) ABSTRACT

A transmission information determining method, a configuration information sending method, a terminal, and a device, are provided. The transmission information determining method includes: obtaining configuration information, where the configuration information is used for configuring an uplink muting pattern, and the uplink muting pattern is used for indicating resources on which transmission is not performed; and determining transmission information of an uplink channel based on a number of first Resource Elements (REs), where the number of the first REs is the number of REs that are associated with the uplink muting pattern and on which transmission is not performed, and the uplink channel includes: a Physical Uplink Shared CHannel (PUSCH).

### CROSS-REFERENCE TO RELATED APPLICATIONS

This application is a continuation of International Application No. PCT/CN2024/091302, filed May 7, 2024, which claims priority to Chinese Patent No. 202310536774.5, filed May 12, 2023. The entire contents of each of the above-referenced applications are expressly incorporated herein by reference.

### TECHNICAL FIELD

This application is directed to the field of communication technologies, and specifically, relates to a transmission information determining method, a configuration information sending method, a terminal, and a device.

### BACKGROUND

Before transmission of an uplink channel, the terminal needs to determine transmission information of the uplink channel, such as a Transport block size (TBS), a transmission resource, the number of Physical Resource Blocks (PRBs), and the number of transmitted Channel State Information (CSI). However, in some related technologies, a manner of determining transmission information of the uplink channel is only applicable to some conventional resource allocation scenarios, which leads to poor transmission performance of the terminal.

### SUMMARY

Embodiments of this application provide a transmission information determining method, a configuration information sending method, a terminal, and a device.

According to a first aspect, a transmission information determining method is provided and includes:
obtaining, by a terminal, configuration information, where the configuration information is used for configuring an uplink muting pattern, and the uplink muting pattern is used for indicating resources on which transmission is not performed; and
determining, by the terminal, transmission information of an uplink channel based on the number of first resource elements (Resource Element, RE), where the number of first REs is the number of REs that are associated with the uplink muting pattern and on which transmission is not performed, and the uplink channel includes at least one of the following:
a physical uplink shared channel (Physical Uplink Shared Channel, PUSCH) and a physical uplink control channel (Physical uplink control channel, PUCCH).

According to a second aspect, a configuration information sending method is provided, including:
sending, by a network-side device, configuration information to a terminal, where the configuration information is used for configuring an uplink muting pattern, and the uplink muting pattern is used for indicating resources on which transmission is not performed.

According to a third aspect, a transmission information determining apparatus is provided, including:
an obtaining module, configured to obtain configuration information, where the configuration information is used for configuring an uplink muting pattern, and the uplink muting pattern is used for indicating resources on which transmission is not performed; and
a determining module, configured to determine transmission information of an uplink channel based on the number of first resource elements REs, where the number of first REs is the number of resource elements REs that are associated with the uplink muting pattern and on which transmission is not performed, and the uplink channel includes at least one of the following:
a physical uplink shared channel PUSCH and a physical uplink control channel PUCCH.

According to a second aspect, a configuration information sending apparatus is provided, including:
a sending module, configured to send configuration information to a terminal, where the configuration information is used for configuring an uplink muting pattern, and the uplink muting pattern is used for indicating resources on which transmission is not performed.

According to a fifth aspect, a terminal is provided, where the terminal includes a processor and a memory, where a program or instructions capable of running on the processor are stored in the memory. When the program or the instructions are executed by the processor, the steps of the transmission information determining method provided in the embodiments of this application are implemented.

According to a sixth aspect, a terminal is provided, including a processor and a communication interface, where the communication interface is configured to obtain configuration information, where the configuration information is used for configuring an uplink muting pattern, and the uplink muting pattern is used for indicating resources on which transmission is not performed; and the processor is configured to determine transmission information of an uplink channel based on the number of first resource elements REs, where the number of first REs is the number of REs that are associated with the uplink muting pattern and on which transmission is not performed, and the uplink channel includes at least one of the following: a PUSCH and a PUCCH.

According to a seventh aspect, a network-side device is provided, where the network-side device includes a processor and a memory, where a program or instructions capable of running on the processor are stored in the memory. When the program or the instructions are executed by the processor, the steps of the configuration information sending method provided in the embodiments of this application are implemented.

According to an eighth aspect, a network-side device is provided, including a processor and a communication interface, where the communication interface is configured to send configuration information to a terminal, where the configuration information is used for configuring an uplink muting pattern, and the uplink muting pattern is used for indicating resources on which transmission is not performed.

According to a ninth aspect, a readable storage medium is provided, where a program or instructions are stored in the readable storage medium, and in a case that the program or the instructions are executed by a processor, the steps of the transmission information determining method provided in the embodiments of this application are implemented, or the steps of the configuration information sending method provided in the embodiments of this application are implemented.

According to a tenth aspect, a wireless communication system is provided, including a terminal and a network-side device, where the terminal can be configured to execute the steps of the transmission information determining method provided in the embodiments of this application, and the network-side device can be configured to execute the steps of the configuration information sending method provided in the embodiments of this application.

According to an eleventh aspect, a chip is provided, where the chip includes a processor and a communication interface, the communication interface is coupled to the processor, and the processor is configured to run a program or instructions to implement the transmission information determining method provided in the embodiments of this application are implemented, or implement the configuration information sending method provided in the embodiments of this application.

According to a twelfth aspect, a computer program/program product is provided, where the computer program/program product is stored in a storage medium, and the program/program product is executed by at least one processor to implement the steps of the transmission information determining method provided in the embodiments of this application, or the program/program product is executed by at least one processor to implement the steps of the configuration information sending method provided in the embodiments of this application.

### BRIEF DESCRIPTION OF DRAWINGS

FIG. 1 is a block diagram of a wireless communication system to which embodiments of this application are applicable;

FIG. 2 is a flowchart of a transmission information determining method according to an embodiment of this application;

FIG. 3 is a schematic diagram of interference in some embodiments of this application;

FIG. 4 is a flowchart of a configuration information sending method according to an embodiment of this application;

FIG. 5 is a structural diagram of a transmission information determining apparatus according to an embodiment of this application;

FIG. 6 is a structural diagram of a configuration information sending apparatus according to an embodiment of this application;

FIG. 7 is a structural diagram of a communication device according to an embodiment of this application;

FIG. 8 is a structural diagram of a terminal according to an embodiment of this application; and

FIG. 9 is a structural diagram of a network-side device according to an embodiment of this application.

### DETAILED DESCRIPTION

The following describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first,” “second,” and the like in this application are used to distinguish between similar objects instead of describing a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, the “or” in this application means at least one of the associated objects. For example, “A or B” covers three schemes, namely, scheme 1: including A not B; scheme 2: including B not A; and scheme 3: including both A and B. The character “/” generally indicates an “or” relationship between associated objects.

The term “indication” in this application may be either a direct indication (or an explicit indication) or an indirect indication (or an implicit indication). The direct indication may be understood as: a sender explicitly notifies, in a sent indication, a receiver of content such as specific information, an operation that needs to be performed, or a request result; and the indirect indication may be understood as: the receiver determines corresponding information or performs determining according to the indication sent by the sender, and determines, according to a determining result, an operation that needs to be performed or a request result.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), or other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other systems than an NR system, for example, the 6^{th} Generation (6G) communication system.

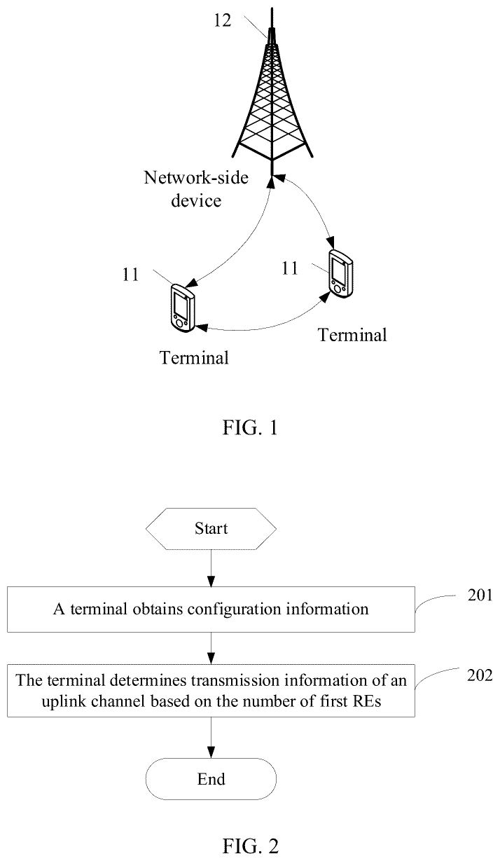

FIG. 1 is a block diagram of a wireless communication system to which the embodiments of this application are applicable. The wireless communication system includes a terminal 11 and a network-side device 12. The terminal 11 may be a terminal-side device such as a mobile phone, a tablet computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR) or Virtual Reality (VR) device, a robot, a wearable device, a flight vehicle, Vehicle User Equipment (VUE), ship equipment, Pedestrian User Equipment (PUE), a smart home device (a home device with wireless communication function, such as a refrigerator, a television, a washing machine, or a furniture), a game console, a personal computer, a teller machine, a self-service machine, or the like. The wearable device includes: a smart watch, a smart band, smart earphones, smart glasses, smart jewelry (smart bracelet, smart wristband, smart ring, smart necklace, smart anklet, smart ankle bracelet, or the like), smart wristband, smart clothing, and the like. The vehicle user equipment may be referred to as a vehicle-mounted terminal, a vehicle-mounted controller, a vehicle-mounted module, a vehicle-mounted component, a vehicle-mounted chip, or vehicle-mounted unit. It should be noted that the terminal 11 is not limited to any specific type in the embodiments of this application. The network-side device 12 may include an access network device or a core network device, where the access network device may also be referred to as a Radio Access Network (RAN), a radio access network function, or a radio access network unit. The access network device may include a base station, a Wireless Local Area Network (WLAN) Access Point (AP), a Wireless Fidelity (WiFi) node, or the like. The base station may be referred to as a Node B (NB), an Evolved Node B (eNB), a next generation Node B (gNB), a New Radio Node B (NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a Home Node B (HNB), a Home evolved Node B (HeNB), a Transmission Reception Point (TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that in the embodiments of this application, only the core network device in the NR system is introduced as an example, and the specific type of the core network device is not limited.

The following describes in detail a transmission information determining method, a configuration information sending method, a terminal, and a device provided in the embodiments of this application by using some embodiments and application scenarios thereof with reference to the accompanying drawings.

Referring to FIG. 2, FIG. 2 is a flowchart of a transmission information determining method according to an embodiment of this application. As shown in FIG. 2, the method includes the following steps.

Step 201: A terminal obtains configuration information, where the configuration information is used for configuring an uplink muting pattern (uplink muting), and the uplink muting pattern is used for indicating resources on which transmission is not performed.

The obtaining the configuration information by the terminal is receiving configuration information sent by the network-side device, for example, the network-side device configures the configuration information by using higher-layer signaling, for example, configuring the configuration information by using system information or higher-layer Radio Resource Control (RRC).

The configuration information being used for configuring the uplink muting pattern may also be understood that the configuration information is used to indicate the uplink muting pattern.

The resource that is indicated by the uplink muting pattern and on which transmission is not performed may be one or more REs (which may include all REs in one PRB) on which transmission is not performed in one or more PRBs. The one or more PRBs may be PRBs allocated to the terminal, or the one or more PRBs may be some bandwidths or PRBs in some Bandwidth Parts (BWPs). In addition, the PRBs may be default, or pre-configured, or indicated by the uplink muting pattern, which is not limited. The resource that is indicated by the uplink muting pattern and on which transmission is not performed may be indicated by using RE as a granularity (for example, indicating an RE on which transmission is not performed), or may be indicated by using RB as a granularity (for example, indicating an RB on which transmission is not performed).

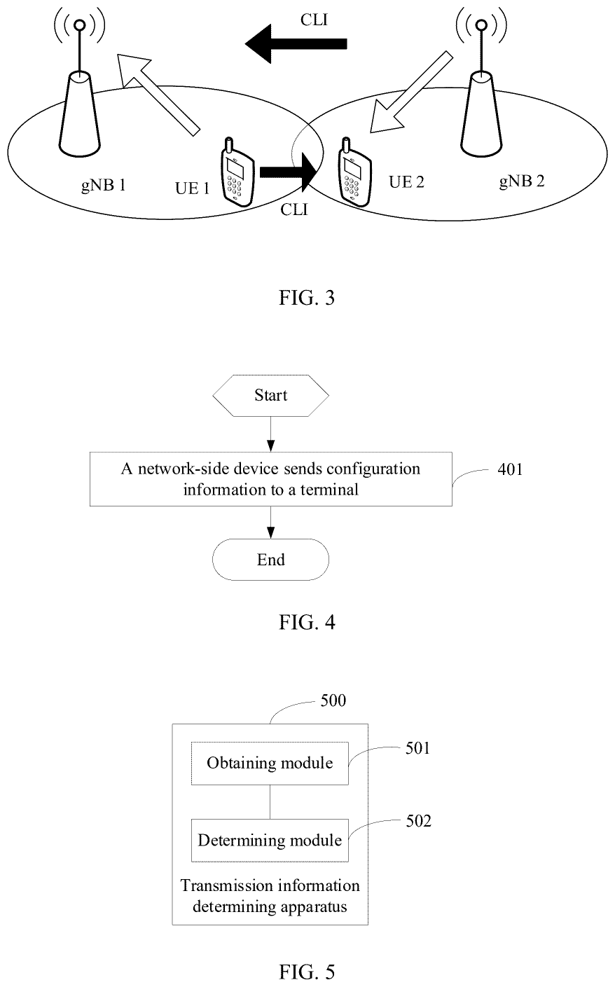

In some implementations, the uplink muting pattern may be an uplink muting pattern generated by avoiding or reducing interference. For example, the uplink muting pattern may be used to avoid or reduce Cross Link Interference (CLI). For example, the resource that is indicated by the uplink muting pattern and on which transmission is not performed is a resource in which a Cross Link Interference Reference Signal (CLI-RS) is located, that is, the resource in which the CLI-RS is located is avoided by using the uplink muting pattern, for example, a Resource block (RB) or an RE in which the CLI-RS is located is avoided. As shown in FIG. 3, the CLI may include a CLI between base stations or a CLI between terminals.

In this way, interference in the communication system can be avoided or reduced by using the uplink muting pattern, so as to improve overall performance of the communication system.

In some implementations, the uplink muting pattern may be indicated by the network-side device to the terminal during uplink scheduling, or may be semi-statically configured, or may be indicated by the network-side device to the terminal during uplink scheduling from multiple uplink muting patterns that are first semi-statically configured; and so on.

It should be noted that in this embodiment of this application, the uplink muting pattern can also be referred to as an uplink rate matching pattern, or an uplink blanking pattern.

In addition, the uplink muting pattern may explicitly or implicitly indicate a resource on which transmission is not performed.

Step 202: The terminal determines transmission information of an uplink channel based on the number of first REs, where the number of first REs is the number of REs that are associated with the uplink muting pattern and on which transmission is not performed, and the uplink channel includes at least one of the following:
a PUSCH and a PUCCH.

The number of REs that are associated with the uplink muting pattern and on which transmission is not performed may be the number of REs included in the transmission resource that is indicated by the uplink muting pattern and on which transmission is not performed, or the number of REs that are corresponding to the uplink muting pattern and on which transmission is not performed in a single or multiple PRBs. For details, refer to the following specific implementations.

The determining the transmission information of the uplink channel based on the number of first REs may be calculating the transmission information of the uplink channel in a case that the uplink channel is not transmitted on the resource indicated by the uplink muting pattern, or calculating the transmission information of the uplink channel in a case that the uplink channel is not mapped to the resource indicated by the uplink muting pattern.

In this embodiment of this application, through the above steps, the transmission information of the uplink channel can be determined in a case that the uplink muting pattern is configured, and then transmission of the uplink channel transmission can be supported in a case that the uplink muting pattern is configured, so as to improve the transmission performance of the terminal. In addition, because the uplink muting pattern is used to indicate the resource on which transmission is not performed, the uplink muting pattern can avoid resources in which other signals are located, so as to avoid or reduce interference, such as avoiding a resource in which the CLI-RS is located.

In some implementations, the transmission information includes at least one of the following:
a TBS;
a transmission resource;
the number of PRBs for transmission;
the number of CSI reports for transmission; and
an effective channel code rate.

The TBS may be a TBS of the PUSCH, the transmission resource may be a transmission resource of the PUSCH or PUCCH; the number of PRBs for transmission may be the number of PRBs for transmission of the PUSCH or PUCCH; the number of CSI reports for transmission may be the number of CSI reports for transmission of the PUSCH or PUCCH; and the effective channel code rate may be an effective channel code rate of the PUSCH or PUCCH.

In this implementation, at least one of the TBS, the transmission resource, the number of PRBs for transmission, the number of CSI reports for transmission, or the effective channel code rate can be determined based on the number of first REs. In this way, the terminal performs transmission based on such transmission information during transmission of the uplink channel, thereby making the uplink channel transmission more reliable.

It should be noted that in this embodiment of this application, part or all of the TBS, the transmission resource, the number of PRBs for transmission, the number of CSI reports for transmission, and the effective channel code rate may be determined based on the number of first REs, and in some cases, the rest of the transmission information may be configured or calculated in other manners, which is not limited.

In some implementations, the determining, by the terminal, transmission information of an uplink channel based on the number of first REs includes:
calculating, by the terminal based on the number of first REs, the number of second REs allocated to the PUSCH in a single PRB, where the number of first REs is the number of REs that are associated with the uplink muting pattern and on which transmission is not performed in a single PRB; and
calculating, by the terminal, a TBS of the PUSCH based on the number of second REs.

The number of second REs allocated to the PUSCH in the single PRB may be the number of REs that can be used to transmit an UpLink Shared Channel (UL-SCH) or uplink control information in one PRB.

In some implementations, the number of second REs is a value obtained by subtracting a first value from a first product, where:
the first product is a product of the number of subcarriers contained in a single PRB and the number of symbols of the PUSCH scheduled in a single slot; and
the first value is a sum of the following three values:
a configured overhead in a serving cell configuration corresponding to the PUSCH, the number of first REs, and the number of REs occupied by a DeModulation Reference Signal (DMRS) in a single PRB within an allocation period of the PUSCH.

The configured overhead in a serving cell configuration corresponding to the PUSCH may be an overhead for a CSI Reference Signal (CSI-RS), a Control Resource SET (CORESET), and the like considered in a serving cell in which the PUSCH is located, for example, a value configured for the overhead (xOverhead) parameter in the higher-layer parameter PUSCH-ServingCellConfig.

In this implementation, the first product may be calculated, and then the overhead configured in the serving cell configuration corresponding to the PUSCH, the number of first REs, and the number of REs occupied by a DMRS in a single PRB within an allocation period of the PUSCH are sequentially subtracted, so as to obtain the number of second REs.

In some implementations, the number of second REs can be calculated by using the following formula:

$${N}_{RE}^{′} = {N}_{sc}^{RB} \times {N}_{symb}^{sh} - {N}_{DMRS}^{PRB} - {N}_{oh}^{PRB} - {N}_{rate - matching} ;$$

where
N_{RE}′ indicates the number of subcarriers included

$${N}_{sc}^{RB}$$

indicates the number of second REs, in a single PRB,

$${N}_{sc}^{RB} = 12$$

indicates 12 subcarriers included in one PRB in frequency domain,

$${N}_{symb}^{sh}$$

indicates the number of symbols of the PUSCH scheduled in a single slot,

$${N}_{DMRS}^{PRB}$$

indicates the number of REs occupied by a demodulation reference signal DMRS in a single PRB in the allocation period of the PUSCH, for example, an overhead of the DMRS in one PRB, and

$${N}_{oh}^{PRB}$$

indicates an overhead configured in the serving cell configuration corresponding to the PUSCH, for example, being configured by using the xOverhead parameter in the higher-layer parameter PUSCH-ServingCellConfig, where an overhead of the CSI-RS and CORESET is mainly considered, a default value is 0, and configurable values are {6, 12, 18}, for example, for message 3 (Msg3) PUSCH transmission,

$${N}_{oh}^{PRB}$$

is set to 0. N_{rate-matching} indicates the number of first REs, such as the number of REs that are indicated by the uplink muting pattern and on which transmission is not performed in one PRB or within the PRB, where the number of first REs may be determined based on the uplink muting pattern or be configured by the higher layer.

It should be noted that the specific implementation of calculating the number of second REs is not limited in this embodiment of this application, for example: In some implementations, second REs allocated to the PUSCH in a single PRB are calculated based on the number of first REs, and the overhead configured in the serving cell configuration corresponding to the PUSCH may not be considered.

In the above implementation, accuracy of the TBS of PUSCH can be improved by using the first RE.

In addition, the calculating the TBS of the PUSCH based on the number of second REs may be calculating in a manner of calculating the TBS of the PUSCH based on the number of REs allocated to the PUSCH in a single PRB, which is defined in the protocol or newly defined later.

In some implementations, the calculating, by the terminal, a TBS of the PUSCH based on the number of second REs can be implemented through the following process:

Step 1: Calculate the total number of REs allocated to the PUSCH in a single slot, that is, the total number of available REs in a slot, where N_{RE}=min(156, N_{RE}′)·n_{PRB}, where n_{PRB} is the number of PRBs allocated to the terminal, N_{RE} indicates the total number of REs allocated to the PUSCH in a single slot, and N_{RE}′ indicates the number of second REs.

Step 2: Calculate the number of intermediate information bits, where N_{info}=N_{RE}·R·Qₘ·ν, where N_{info} indicates the number of intermediate information bits, Qₘ indicates a modulation order corresponding to the PUSCH, R indicates a code rate corresponding to the PUSCH, and ν indicates the number of transport layers of the PUSCH.

When N_{info}≤3824, step 3 is performed; otherwise, step 4 is performed.

### Step 3: Perform Quantization.

When N_{info}≤3824, the number of intermediate information bits

$${N}_{info}^{′} = max ( 24 , {2}^{n} \cdot ⌊ \frac{{N}_{info}}{{2}^{n}} ⌋ )$$

is quantized, where n=max(3,└log₂ (N_{info})┘−6).

A nearest TBS not less than N_{info}′ is found from a predefined table for TBS query.

In some implementations, the above table may be specifically shown in Table 1:

TABLE 1

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

It should be noted that the above table is only an example, and it may be a table for TBS query that has been defined in the protocol or newly defined later.

Step 4: When N_{info}>3824,
the intermediate number

$${N}_{info}^{′} = max ( 3840 , {2}^{n} \times round ( \frac{{N}_{info} - 24}{{2}^{n}} ) )$$

is quantized, where n=└log₂ (N_{info}−24)┘−5.

If the target code rate R≤1/4,

$$TBS = 8 \cdot C \cdot ⌈ \frac{{N}_{info}^{′} + 24}{8 \cdot C} ⌉ - 24 , where C = ⌈ \frac{{N}_{info}^{′} + 24}{3816} ⌉ .$$

When (R>1/4):

$$if {N}_{info}^{′} > 8424 , TBS = 8 \cdot C \cdot ⌈ \frac{{N}_{info}^{′} + 24}{8 \cdot C} ⌉ - 24 , where C = ⌈ \frac{{N}_{info}^{′} + 24}{8424} ⌉ ;$$

$$otherwise , TBS = 8 \cdot ⌈ \frac{{N}_{info}^{′} + 24}{8} ⌉ - 24.$$

In some implementations, the determining, by the terminal, transmission information of an uplink channel based on the number of first REs includes:
calculating, by the terminal, the number of third REs allocated to the PUSCH in a single PRB;
calculating, by the terminal, the total number of REs allocated to the PUSCH in a single slot based on the number of first REs, the number of third REs, and the number of PRBs allocated to the terminal, where the number of first REs is the number of REs that are associated with the uplink muting pattern and on which transmission is not performed in a PRB for transmitting the PUSCH; and
calculating, by the terminal, a TBS of the PUSCH based on the total number of REs.

The calculating the number of third REs allocated to the PUSCH in a single PRB may be calculating the number of third REs allocated to the PUSCH in a single PRB in a manner defined by the protocol or newly defined later. For example, the number of third REs allocated to the PUSCH in a single PRB is calculated in the following manner:

$${N}_{RE}^{′} = {N}_{sc}^{RB} \cdot {N}_{symb}^{sh} - {N}_{DMRS}^{PRB} - {N}_{oh}^{PRB} ;$$

N_{RE}′ indicates the number of third REs,

$${N}_{sc}^{RB}$$

indicates the number of subcarriers included in a single PRB,

$${N}_{sc}^{RB} = 12$$

indicates 12 subcarriers included in one PRB in frequency domain,

$${N}_{symb}^{sh}$$

indicates the number of symbols of the PUSCH scheduled in a single slot,

$${N}_{DMRS}^{PRB}$$

indicates the number of REs occupied by a demodulation reference signal DMRS in a single PRB in the allocation period of the PUSCH, for example, an overhead of the DMRS in one PRB, and

$${N}_{oh}^{PRB}$$

indicates an overhead configured in the serving cell configuration corresponding to the PUSCH, for example, being configured by using the xOverhead field in the higher-layer parameter PUSCH-ServingCellConfig, where an overhead of the CSI-RS and CORESET is mainly considered, a default value is 0, and configurable values are {6,12,18}, for example, for message 3 (Msg3) PUSCH transmission,

$${N}_{oh}^{PRB}$$

is set to ν.

The number of PRBs allocated to the terminal is the number of PRBs configured before configuring the uplink muting pattern or performing rate matching. In addition, the number of PRBs allocated to the terminal may be the total number of PRBs allocated to the terminal.

In some implementations, the total number of REs is a value obtained by subtracting the number of first REs from a second product, where:
the second product is a product of a minimum value and the number of PRBs allocated to the terminal, and the minimum value is a minimum value in the number of third REs and a preset threshold.

The preset threshold can be specified by the protocol or configured by the network side, for example, 156.

In this implementation, a minimum value selected from the number of third REs and the preset threshold is multiplied by the number of PRBs allocated to the terminal, and then the number of first REs is subtracted to obtain the total number of REs.

In some implementations, based on the number of first REs, the number of third REs, and the number of PRBs allocated to the terminal, the total number of REs allocated to the PUSCH in a single slot can be calculated in the following manner:

$${N}_{RE} = min ( 156 , {N}_{RE}^{′} ) \cdot {n}_{PRB} - {N}_{rate - matching} ;$$

N_{RE} indicates the total number of REs, N_{RE}′ indicates the number of third RES, n_{PRB} indicates the number of PRBs allocated to the terminal, and N_{rate-matching} indicates the number of first REs, such as the number of REs that are indicated by the uplink muting pattern and on which transmission is not performed in all PRBs in which the PUSCH is located, where the number of first REs may be determined based on the uplink muting pattern or be configured by the higher layer.

In the above implementation, the TBS of the PUSCH can be calculated accurately based on the number of first REs.

It should be noted that in the above implementations, based on the total number of REs, the TBS of the PUSCH can be calculated in a manner defined in the protocol or newly defined later, which is not limited. In some implementations, the TBS of the PUSCH can be calculated by performing steps 2 to 4 in the above implementation for calculating the TBS of the PUSCH.

In some implementations, in the above implementation of calculating the TBS of the PUSCH, the PUSCH may include at least one of the following:
a dynamically scheduled PUSCH; and
a configured grant PUSCH.

CRC in a Downlink Control Information (DCI) format of the dynamically scheduled PUSCH is scrambled by at least one of the following:
a Cell Radio Network Temporary Identifier (C-RNTI);
a Modulation and Coding Scheme-Cell Radio Network Temporary Identifier (MCS-C-RNTI); and
a Configured Scheduling Network Temporary Identifier (CS-RNTI).

In this way, by calculating the TBS of the PUSCH, the transmission performance of such PUSCHs can be improved.

In some implementations, the number of PRBs for transmission includes: a minimum number of PRBs for transmission of the PUCCH, where:
a value of the minimum number of PRBs for transmission of the PUCCH is a minimum value of the number of PRBs for transmission of the PUCCH in a case that the number of PRBs for transmission of the PUCCH meets a first condition; that is, the number of PRBs used for actual transmission of the PUCCH; and
the first condition is a condition including the number of first REs.

The minimum value of the number of PRBs for transmission of the PUCCH in a case that the number of PRBs for transmission of the PUCCH meets the first condition can be understood as the minimum number of PRBs for transmission of the PUCCH in a case that the first condition is met, that is, the minimum number of PRBs used for transmission of the PUCCH in a case that the first condition is met.

A condition for the first condition including the number of first REs can be understood as a condition corresponding to the number of first REs, that is, the minimum number of PRBs for transmission of the PUCCH is determined based on the number of first REs.

In this implementation, the minimum number of PRBs for transmission of the PUCCH can be determined, which can improve the reliability of PUCCH transmission.

In some implementations, the first condition includes:

$$( {O}_{UCI} + {O}_{CRC} ) \leq ( {M}_{RB , min}^{PUCCH} \cdot {N}_{s c , ctrl}^{RB} \cdot {N}_{symb - UCI}^{PUCCH} - M {1}_{RE}^{rate - matchig} ) \cdot {Q}_{m} \cdot r ,$$

$$and$$

$$( {O}_{UCI} + {O}_{CRC} ) > [ ( {M}_{RB , min}^{PUCCH} - 1 ) \cdot {N}_{s c , ctrl}^{RB} \cdot {N}_{symb - UCI}^{PUCCH} - M {2}_{RE}^{rate - matchig} ] \cdot {Q}_{m} \cdot r ;$$

$$or$$

$$( {O}_{UCI} + {O}_{CRC} ) \leq ( {M}_{RB , min}^{PUCCH} \cdot ( {N}_{s c , ctrl}^{RB} \cdot {N}_{symb - UCI}^{PUCCH} - M {2}_{RE}^{rate - matchig} ) ) \cdot {Q}_{m} \cdot r ,$$

$$and$$

$$( {O}_{UCI} + {O}_{CRC} ) > [ \text{} ( {M}_{RB , min}^{PUCCH} - 1 ) \cdot ( {N}_{s c , ctrl}^{RB} \cdot {N}_{symb - UCI}^{PUCCH} - M {3}_{RE}^{rate - matchig} ) ] \cdot {Q}_{m} \cdot r .$$

$$M {1}_{RE}^{rate - matchig}$$

indicates a first value of the number of first REs, and the first value is the number of REs that are associated with the uplink muting pattern and on which transmission is not performed in

$${M}_{RB , min}^{PUCCH}$$

PRBs for transmission of the PUCCH within a symbol for transmitting Uplink Control Information (UCI) on the PUCCH.

$$M {2}_{RE}^{rate - matchig}$$

indicates a second value of the number of first REs, and the second value is the number of REs that are associated with the uplink muting pattern and on which transmission is not performed in

$${M}_{RB , min}^{PUCCH} - 1 PRBs$$

for transmission of the PUCCH within a symbol for transmitting UCI on the PUCCH.

$$M {3}_{RE}^{rate - matchig}$$

indicates a third value of the number of first REs, and the third value is the number of REs that are associated with the uplink muting pattern and on which transmission is not performed in a single PRB within a symbol for transmitting UCI on the PUCCH.

O_{CRC} indicates the number of bits of Cyclic Redundancy Check (CRC) information transmitted on the PUCCH, and O_{UCI} indicates the number of bits of UCI transmitted on the PUCCH.

$${M}_{RB , min}^{PUCCH}$$

indicates the minimum number of PRBs for transmission of the PUCCH, that is, the number of PRBs used in actual transmission of the PUCCH.

$${N}_{symb - UCI}^{P UCCH}$$

indicates the number of symbols available for transmitting UCI on the PUCCH, and

$${N}_{sc , ctrl}^{RB }$$

indicates the number of subcarriers available for transmitting UCI in a single PRB.

Qₘ indicates a modulation order corresponding to the PUCCH, and r indicates a code rate corresponding to the PUCCH.

The UCI may include at least one of the following:
a Hybrid Automatic Repeat reQuest ACKnoledgement (HARQ-ACK), a Scheduling Request (SR), and CSI.

O_{UCI} can indicate the number of bits of at least one of the following: HARQ-ACK, SR, and CSI transmitted on the PUCCH. For example, the UCI may be HARQ-ACK, HARQ-ACK+SR, CSI, CSI+HARQ-ACK, CSI+SR, or CSI+HARQ-ACK+SR.

In this implementation, a more reasonable minimum number of PRBs for transmission of the PUCCH can be determined based on the first condition, so as to improve the reliability of PUCCH transmission.

It should be noted that in this embodiment of this application, the first condition is not limited to the first condition expressed by the above multiple formulas, and the first condition may be specifically specified by the protocol or configured by the network side.

In some implementations, the number of CSI reports for transmission includes the number of CSI reports transmitted on the PUCCH, where:
in a case that a second condition is met, the number of CSI reports transmitted on the PUCCH is the total number of CSI reports that need to be multiplexed and transmitted on the PUCCH; or
in a case that the second condition is not met, the number of CSI reports transmitted on the PUCCH is a second value, and the CSI reports transmitted on the PUCCH are a second-value number of CSI reports selected in ascending order of priority values in CSI reports to be multiplexed and transmitted on the PUCCH, where the second value is a maximum number of CSI reports determined in a case that a transmission code rate is not greater than a configured code rate; where
the second condition is a condition including the number of first REs.

The foregoing number of CSI reports transmitted on the PUCCH may be the number of CSI reports transmitted on the PUCCH, or the number of CSI first parts (part 1) transmitted on the PUCCH or the number of CSI second parts (part 2) transmitted on the PUCCH.

In addition, when CSI part 1 and CSI part 2 are included, if a transmission code rate of the UCI is greater than a code rate configured for the PUCCH, CSI part 2 is discarded first, and CSI part 1 is not be discarded until CSI part 2 of all CSI reports is discarded.

The second value being the maximum number of CSI reports determined in a case that the transmission code rate is not greater than the configured code rate can be the maximum number of CSI reports that the PUCCH can transmit in a case that the transmission code rate is not greater than the configured code rate of the PUCCH.

In some implementations, the second condition includes:

$$\begin{matrix}( {O}_{UCI} + {O}_{C R C} ) \leq ( {M}_{P R B}^{P U C C H} \cdot {N}_{sc , ctrl}^{R B} \cdot {N}_{symb - uci}^{P U C C} - M {4}_{R E}^{r a t e - m a t c h i g} ) \cdot {Q}_{m} \cdot r ; or \\ ( {O}_{UCI} + {O}_{C R C} ) \leq ( {M}_{P R B}^{P U C C H} . ( {N}_{sc , ctrl}^{R B} \cdot {N}_{symb - uci}^{P U C C} - M {5}_{R E}^{r a t e - m a t c h i g} ) ) \cdot {Q}_{m} \cdot r . \\ M {4}_{R E}^{r a t e - m a t c h i g}\end{matrix}$$

indicates a fourth value of the number of first REs, where the fourth value is the number of REs that are associated with the uplink muting pattern and on which transmission is not performed in

$${M}_{P R B}^{P U C C H}$$

PRBS within a symbol for transmitting UCI on the PUCCH.

$$M {5}_{R E}^{rate - matchig}$$

indicates a fifth value of the number of first REs, where the fifth value is the number of REs that are associated with the uplink muting pattern and on which transmission is not performed in a single PRB within a symbol for transmitting UCI on the PUCCH.

O_{CRC} indicates the number of bits of cyclic redundancy check CRC information for transmission of the PUCCH, and O_{UCI} indicates the number of bits of UCI transmitted on the PUCCH, where the UCI contains CSI, such as O_{UCI}=O_{HARQ-ACK}+O_{SR}+O_{CSI};

$${M}_{P R B}^{P U C C H}$$

indicates the number of PRBs configured for the PUCCH.

$${N}_{symb - UCI}^{P UCCH}$$

indicates the number of symbols available for transmitting UCI on the PUCCH, and

$${N}_{sc , ctrl}^{R B}$$

indicates the number of subcarriers available for transmitting UCI in a single PRB.

Qₘ indicates a modulation order corresponding to the PUCCH, and r indicates a code rate corresponding to the PUCCH.

In this implementation, the number of CSI reports transmitted on the PUCCH can be made more reasonable based on the second condition, so as to improve the transmission performance of the PUCCH.

It should be noted that in this embodiment of this application, the second condition is not limited to the second condition expressed by the above multiple formulas, and the second condition may be specifically specified by the protocol or configured by the network side.

The second-value number of CSI reports selected in ascending order of priority values in CSI reports to be multiplexed and transmitted on the PUCCH can be referred to as the second-value number of CSI reports selected based on an order of priorities of the CSI reports to be multiplexed and transmitted on the PUCCH. In addition, in this embodiment of this application, the second-value number of CSIs selected in ascending order of priority values is not limited, for example, the second-value number of CSIs is determined based on a predefined order of all CSIs to be multiplexed and transmitted on the PUCCH.

In some implementations, in an embodiment A (for example, the terminal transmits HARQ-ACK, SR, and CSI on one PUCCH, where the CSI report contains only CSI part 1 (part 1)), and the second value meets at least one of the following conditions:

$$( {O}_{A C K} + {O}_{S R} + {\sum }_{n = 1}^{{N}_{CSI}^{r e p o r t e d}} {O}_{CSI - part 1 , n} + {O}_{CRC , CSI - part 1 , N} ) \leq ( {M}_{P R B}^{P U C C H} \cdot {N}_{sc , ctrl}^{R B} \cdot {N}_{symb - uci}^{P UCCH} - {M}_{R E}^{rate - matchig} ) \cdot {Q}_{m} \cdot r ;$$

$$( {O}_{ACK} + {O}_{S R} + {\sum }_{n = 1}^{{N}_{CSI}^{reported}} {O}_{CSI - part 1 , n} + {O}_{CRC , CSI - part 1 , N} ) \leq {M}_{R B}^{PUCCH} \cdot {N}_{s c . ctrl}^{R B} \cdot {N}_{s ymb , UCI}^{PUCCH} \cdot {Q}_{m} \cdot r ; and$$

$$( {O}_{A C K} + {O}_{S R} + {\sum }_{n = 1}^{{N}_{CSI}^{r e p o r t e d} + 1} {O}_{CSI - part 1 , n} + {O}_{CRC , CSI - part 1 , N + 1} ) > ( {M}_{P R B}^{PUCCH} \cdot {N}_{sc , ctrl}^{R B} \cdot {N}_{s y m b - u c i}^{PUCCH} - {M}_{R E}^{rate - matchig} ) \cdot {Q}_{m} \cdot r .$$

$${N}_{CSI}^{reported}$$

indicates the second value, O_{ACK} indicates the number of bits (which may be 0, indicating that the UCI transmitted on the PUCCH does not contain HARQ-ACK information) of the HARQ-ACK information transmitted on the PUCCH, and O_{SR} indicates the number of bits (which may be 0, indicating that the UCI transmitted on the PUCCH does not contain SR information) the of SR information transmitted on the PUCCH.

O_{CRC,CSI-part1,N} indicates the number of CRC bits corresponding to

$${O}_{A C K} + {O}_{S R} + {\sum }_{n = 1}^{{N}_{CSI}^{r e p o r t e d}} {O}_{CSI - part 1 , n} ,$$

where O_{CSI-part1,n} indicates the number of bits of a first part of the n-th CSI report (that is, the number of bits in part 1 of the n-th CSI report).

O_{CRC,CSI-part1,N+1} indicates the number of CRC bits corresponding to

$${O}_{A C K} + {O}_{S R} + {\sum }_{n = 1}^{{N}_{CSI}^{r e p o r t e d} + 1} {O}_{CSI - part 1 , n} ,$$

where O_{CSI-part1,n} indicates the number of bits of a first part of the n-th CSI report (that is, the number of bits in part 1 of the n-th CSI report),

$${M}_{P R B}^{P U C C H}$$

indicates the number of PRBs configured for the PUCCH, and

$${M}_{R B}^{P U C C H}$$

indicates the number of PRBs configured for the PUCCH.

$${N}_{symb - UCI}^{P UCCH}$$

indicates the number of symbols available for transmitting UCI on the PUCCH, and

$${N}_{sc , ctrl}^{RB }$$

indicates the number of subcarriers available for transmitting UCI in a single PRB. For example, for PUCCH format 2,

$${N}_{s c , ctrl}^{RB} = {N}_{s c}^{R B} - 4 ,$$

or for PUNCH format 2 and an orthogonal cover code (orthogonal cover code, OCC) length corresponding to the PUCCH being

$${N}_{SF}^{PUCCH , 2} , {N}_{s c , ctrl}^{R B} = ( {N}_{sc}^{RB} - 4 ) / {N}_{S F}^{PUCCH , 2} .$$

For PUCCH format 3,

$${N}_{s c , ctrl}^{RB} = {N}_{s c}^{RB} ,$$

or for PUCCH format 3 and the OCC length corresponding to the PUCCH being

$${N}_{SF}^{PUCCH , 3} , {N}_{s c , ctrl}^{R B} = {N}_{s c}^{RB} / {N}_{SF}^{PUCCH , 3} .$$

For PUCCH format 4,

$${N}_{sc , ctrl}^{R B} = {N}_{s c}^{RB} / {N}_{S F}^{PUCCH , 4} ,$$

where

$${N}_{ sc}^{RB}$$

indicates the number of subcarriers in one RB,

$${N}_{s c}^{R B} = 12 , and {N}_{S F}^{PUCCH , 4}$$

indicates the OCC length corresponding to PUCCH format 4.

$${N}_{symb - UCI}^{PUCCH}$$

indicates a symbol format in which the PUCCH can transmit UCI, for example, for PUCCH format 2, it is equal to the number of OFDM symbols configured for the PUCCH, such as the parameter nrofSymbols; or for PUCCH formats 3 and 4, it is equal to the number of symbols configured for the PUCCH minus the number of symbols occupied by the DMRS.

$${M}_{RE}^{rate - matching}$$

indicates the number of first REs, where the number of first REs is the number of REs that are associated with the uplink muting pattern and on which transmission is not performed in a symbol for transmitting uplink control information UCI on the PUCCH.

Qₘ indicates a modulation order corresponding to the PUCCH, and r indicates a code rate corresponding to the PUCCH.

The number of PRBs configured for the PUCCH may be the number of PRBs configured for the PUCCH for transmitting CSI.

In some implementations, in another embodiment B (for example, the terminal transmits HARQ-ACK, SR, and CSI on one PUCCH, and a CSI report contains a second part (part 2) of CSI); and in a case that the fifth condition is met, the second value includes the number of second parts of CSI reports transmitted on the PUCCH, and the total number of first parts of CSI reports that need to be multiplexed and transmitted on the PUCCH.

The fifth condition is at least one of the following:

$${\sum }_{n = 1}^{{N}_{CSI - part 2}^{r e p o r t e d}} {O}_{CSI - part 2 , n} + {O}_{CRC , CSI - part 2 , N} \leq ( {M}_{R B}^{PUCCH} \cdot {N}_{sc , ctrl}^{R B} \cdot {N}_{symb - uci}^{PUCCH} - [ ( {O}_{ACK} + {O}_{S R} + {\sum }_{n = 1}^{{N}_{CSI}^{t o t a l}} {O}_{CSI - part 1 , n} + {O}_{CRC , CSI - part 1} ) / ( {Q}_{m} \cdot r ) ] ) \cdot {Q}_{m} \cdot r ;$$

$$and$$

$${\sum }_{n = 1}^{{N}_{CSI - part 2}^{reported} + 1} {O}_{CSI - part 2 , n} + {O}_{CRC , CSI - part 2 , N + 1} > ( {M}_{R B}^{PUCCH} \cdot {N}_{sc , ctrl}^{RB} \cdot {N}_{symb - uci}^{PUCCH} - [ ( {O}_{ACK} + {O}_{SR} + {\sum }_{n = 1}^{{N}_{CSI}^{t o t a l}} {O}_{CSI - part 1 , n} + {O}_{CRC , CSI - part 1} ) / ( {Q}_{m} \cdot r ) ] ) \cdot {Q}_{m} \cdot r .$$

$${N}_{CSI - part 2}^{reported}$$

indicates the number of second parts of CSI reports transmitted on the PUCCH.

O_{ACK} indicates the number of bits of HARQ-ACK information transmitted on the PUCCH, and O_{SR} indicates the number of bits of SR information transmitted on the PUCCH.

O_{CRC,CSI-part2,N} indicates the number of CRC bits corresponding to

$${O}_{ACK} + {O}_{SR} + {\sum }_{n = 1}^{{N}_{CSI}^{reported}} {O}_{CSI - part 2 , n} ,$$

where O_{CSI-part2,n} indicates the number of bits of the second part of the n-th CSI report.

O_{CRC,CSI-part2,N+1} indicates the number of CRC bits corresponding to

$${O}_{ACK} + {O}_{SR} + {\sum }_{n = 1}^{{N}_{CSI}^{reported}} {O}_{CSI - part 2 , n} ,$$

where O_{CSI-part2,n} indicates the number of bits of the second part of the n-th CSI report.

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

where O_{CSI-part1,n} indicates the number of bits of a first part of the n-th CSI report.

$${N}_{CSI}^{total}$$

indicates the total number of CSI reports that need to be multiplexed and transmitted on the PUCCH.

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB}$$

Indicates the number of subcarriers available for transmitting UCI in a single PRB.

Qₘ indicates a modulation order corresponding to the PUCCH, and r indicates a code rate corresponding to the PUCCH.

In this embodiment, the PUCCH transmits all CSI parts 1, and transmits

$${N}_{CSI - part 2}^{reported}$$

CSI parts 2.

In some implementations, in another embodiment (if the terminal transmits HARQ-ACK, SR, and CSI on one PUCCH, where a CSI includes CSI part 1 and CSI part 2, but if the condition is not met according to the foregoing embodiment B, the UE discards all CSI parts 2, and determines the number of CSI parts 1 for transmission in the following manner), in a case that the fifth condition is not met, the second value is equal to the number of first parts of CSI reports transmitted on the PUCCH and meeting a sixth condition; and
the sixth condition includes at least one of the following:

$$( {O}_{ACK} + {O}_{SR} + {\sum }_{n = 1}^{{N}_{CSI - part 1}^{reported}} {O}_{CSI - part 1 , n} + {O}_{CRC , CSI - part 1 , N} ) \leq {M}_{RB}^{PUCCH} \cdot {N}_{sc , ctrl}^{RB} \cdot {N}_{symb - UCI}^{PUCCH} \cdot {Q}_{m} \cdot r ; and$$

$$( {O}_{ACK} + {O}_{SR} + {\sum }_{n = 1}^{{N}_{CSI - part 1}^{reported} + 1} {O}_{CSI - part 1 , n} + {O}_{CRC , CSI - part 1 , N + 1} ) > {M}_{RB}^{PUCCH} \cdot {N}_{sc , ctrl}^{RB} \cdot {N}_{symb - UCI}^{PUCCH} \cdot {Q}_{m} \cdot r .$$

$${N}_{CSI - part 1}^{reported}$$

indicates the number of first parts of CSI reports transmitted on the PUCCH.

O_{ACK} indicates the number of bits of HARQ-ACK information transmitted on the PUCCH, and, O_{SR} indicates the number of bits of SR information transmitted on the PUCCH.

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

where O_{CSI-part1,n} indicates the number of bits of the first part of the n-th CSI report.

O_{CRC,CSI-part1,N+1} indicates the number of CRC bits corresponding to

$${O}_{ACK} + {O}_{SR} + {\sum }_{n = 1}^{{N}_{CSI}^{reported} + 1} {O}_{CSI - part 1 , n} .$$

$${N}_{CSI}^{total}$$

indicates the total number of CSI reports that need to be multiplexed and transmitted on the PUCCH.

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB}$$

indicates the number or subcarriers available for transmitting UCI in a single PRB.

Qₘ indicates a modulation order corresponding to the PUCCH, and r indicates a code rate corresponding to the PUCCH.

In this embodiment, the PUCCH transmits

$${N}_{CSI - part 1}^{reported}$$

CSI parts 1, and does not transmit CSI part 2.

In this implementation, the determined number of CSI reports transmitted on the PUCCH can be made more reasonable by using at least one formula above, so as to improve the transmission performance of the PUCCH.

In some implementations, the transmission resource includes a transmission resource of the PUCCH, where
the transmission resource of the PUCCH includes a resource selected on J PUCCH resources in at least one of the following manners:
in a case that a third condition is met, selecting a PUCCH resource with an index of 0 from the J PUCCH resources, where the third condition is a condition including the number of first REs, and J is a positive integer:
in a case that the third condition is not met and the fourth condition is met, selecting a PUCCH resource with an index of j+1 from the J PUCCH resources, where the fourth condition is a condition including the number of first REs, and 5≤j<J−1; and
   in a case that the third condition is not met and the fourth condition is not met, selecting a PUCCH resource with an index of J−1 from the J PUCCH resources; where
the J PUCCH resources are PUCCH resources used for transmitting multiple CSIs, and resource indexes of the J PUCCH resources are numbered in ascending order of products of the corresponding number of REs, a modulation order and a configured code rate.

The J PUCCH resources may be resources configured by the network side for transmitting the PUCCH containing multiple CSIs, such as J PUCCH resources configured by using a multi-CSI-PUCCH resource list (multi-CSI-PUCCH-ResourceList).

In some implementations, J is a positive integer greater than 1, and may be an integer less than or equal to 2.

In this implementation, the third condition and the fourth condition can make the selected PUCCH resources more reasonable, so as to improve the transmission performance of the PUCCH.

In some implementations, the third condition includes:

$$( {O}_{UCI} + {O}_{CRC} ) \leq {[ ( {M}_{PRB}^{PUCCH} \cdot {N}_{sc , ctrl}^{RB} \cdot {N}_{symb - uci}^{PUCCH} - M {6}_{RE}^{rate - matchig} ) \cdot {Q}_{m} \cdot r ]}_{0} ; or$$

$$( {O}_{UCI} + {O}_{CRC} ) \leq {[ ( {M}_{PRB}^{PUCCH} \cdot ( {N}_{sc , ctrl}^{RB} \cdot {N}_{symb - uci}^{PUCCH} - M {7}_{RE}^{rate - matchig} ) ) \cdot {Q}_{m} \cdot r ]}_{0}$$

The fourth condition includes:

$$( {O}_{UCI} + {O}_{CRC} ) > {[ ( {M}_{PRB}^{PUCCH} \cdot {N}_{sc , ctrl}^{RB} \cdot {N}_{symb - uci}^{PUCCH} - M {6}_{RE}^{rate - matchig} ) \cdot {Q}_{m} \cdot r ]}_{j} , and$$

$$( {O}_{UCI} + {O}_{CRC} ) \leq {[ ( {M}_{PRB}^{PUCCH} \cdot {N}_{sc , ctrl}^{RB} \cdot {N}_{symb - uci}^{PUCCH} - M {6}_{RE}^{rate - matchig} ) \cdot {Q}_{m} \cdot r ]}_{j + 1} , where 0 \leq j < J - 1 ; or$$

$$( {O}_{UCI} + {O}_{CRC} ) > {[ ( {M}_{PRB}^{PUCCH} \cdot ( {N}_{sc , ctrl}^{RB} \cdot {N}_{symb - uci}^{PUCCH} - M {7}_{RE}^{rate - matchig} ) ) \cdot {Q}_{m} \cdot r ]}_{j} , and ( {O}_{UCI} + {O}_{CRC} ) \leq {[ ( {M}_{PRB}^{PUCCH} \cdot ( {N}_{sc , ctrl}^{RB} \cdot {N}_{symb - uci}^{PUCCH} - M {7}_{RE}^{rate - matchig} ) ) \cdot {Q}_{m} \cdot r ]}_{j + 1} , where 0 \leq j < J - 1.$$

$$M {6}_{RE}^{rate - matchig}$$

indicates a sixth value of the number of first REs, where the sixth value is the number of REs that are associated with the uplink muting pattern and on which transmission is not performed within a symbol for transmitting UCI on the PUCCH.

$$M {7}_{RE}^{rate - matchig}$$

indicates a seventh value of the number of first REs, where the seventh value is the number of REs that are associated with the uplink muting pattern and on which transmission is not performed in a single PRB within a symbol for transmitting UCI on the PUCCH.

O_{CRC} indicates the number of bits of cyclic redundancy check CRC information for transmission of the PUCCH, and O_{UCI} indicates the number of bits of UCI transmitted on the PUCCH.

$${M}_{PRB}^{PUCCH}$$

indicates the number of PRBs configured for the PUCCH.

$${N}_{symb - UCI}^{P UCCH}$$

indicates the number of symbols available for transmitting UCI on the PUCCH, and N_{sc,ctrl}^{RB} indicates the number of subcarriers available for transmitting UCI in a single PRB.

Qₘ indicates a modulation order corresponding to the PUCCH, and r indicates a code rate corresponding to the PUCCH.

[ ]₀ indicates calculating an operation within [ ] by using information of the PUCCH resource with the index of 0, [ ]ⱼ indicates calculating an operation within [ ] by using information of a PUCCH resource with an index of j, and [ ]ⱼ₊₁ indicates calculating an operation within [ ] by using information of a PUCCH resource with an index of j+1.

In this implementation, the third condition and the fourth condition can make the selected PUCCH resources more reasonable, so as to improve the transmission performance of the PUCCH.

It should be noted that in this embodiment of this application, the third condition is not limited to the third condition expressed by the above multiple formulas, and the third condition may be specifically specified by the protocol or configured by the network side; and in this embodiment of this application, the fourth condition is not limited to the fourth condition expressed by the above multiple formulas, and the fourth condition may be specifically specified by the protocol or configured by the network side.

In some implementations, the number of CSI reports for transmission includes the number of CSI reports transmitted on the PUCCH, where:
in a case that the third condition is met, the number of CSI reports transmitted on the PUCCH is the total number of CSI reports that need to be multiplexed and transmitted on the PUCCH; or
in a case that the third condition is not met and the fourth condition is met, the number of CSI reports transmitted on the PUCCH is the total number of CSI reports that need to be multiplexed and transmitted on the PUCCH; or
in a case that the third condition is not met and the fourth condition is not met, the number of CSI reports transmitted on the PUCCH is a second value, and the CSI reports transmitted on the PUCCH are a second-value number of CSI reports selected in ascending order of priority values in CSI reports to be multiplexed and transmitted on the PUCCH, where the second value is a maximum number of CSI reports determined in a case that a transmission code rate is not greater than a configured code rate.

For the number of CSI reports transmitted on the PUCCH in a case that the third condition is not met and the fourth condition is met, reference may be made to the description of the corresponding embodiment above, and details are not repeated here.

In this implementation, the third condition and the fourth condition can make the selected PUCCH resources more reasonable, so as to improve the transmission performance of the PUCCH.

In some implementations, in an embodiment A (for example, the terminal transmits HARQ-ACK, SR, and CSI on one PUCCH, where the CSI contains only CSI part 1), and the second value meets at least one of the following conditions:

$$( {O}_{A C K} + {O}_{S R} + {\sum }_{n = 1}^{{N}_{CSI}^{reported}} {O}_{CSI - part 1 , n} + {O}_{C R C , CSI - part 1 , N} ) \leq ( {M}_{P R B}^{PUCCH} \cdot {N}_{sc , ctrl}^{R B} \cdot {N}_{symb - uci}^{P UCCH} - {M}_{R E}^{rate - m a t c h i g} ) \cdot {Q}_{m} \cdot r ;$$

$$( {O}_{ACK} + {O}_{S R} + {\sum }_{n = 1}^{{N}_{CSI}^{reported}} {O}_{CSI - part 1 , n} + {O}_{CRC , CSI - part 1 , N} ) \leq {M}_{R B}^{PUCCH} \cdot {N}_{sc , ctrl}^{R B} \cdot {N}_{s ymb - UCI}^{PUCCH} \cdot {Q}_{m} \cdot r ;$$

$$and$$

$$( {O}_{A C K} + {O}_{S R} + {\sum }_{n = 1}^{{N}_{C S}^{reported} + 1} {O}_{CSI - part 1 , n} + {O}_{CRC , CSI - part 1 , N} ) > ( {M}_{P R B}^{PUCCH} \cdot {N}_{sc , ctrl}^{R B} \cdot {N}_{symb - uci}^{P UCCH} - {M}_{R E}^{r a t e - m a t c h i g} ) \cdot {Q}_{m} \cdot r .$$

$${N}_{CSI}^{reported}$$

indicates the second value, O_{ACK} indicates the number of bits of HARQ-ACK information transmitted on the PUCCH, and O_{SR} indicates the number of bits of SR information transmitted on the PUCCH.

O_{CRC,CSI-part1,N} indicates the number of CRC bits corresponding to

$${O}_{A C K} + {O}_{S R} + {\sum }_{n = 1}^{{N}_{CSI}^{reported}} {O}_{CSI - part 1 , n} ,$$

where O_{CSI-part1,n} indicates the number of bits of a first part of the n-th CSI report (that is, the number of bits in part 1 of the n-th CSI report).

$${M}_{P R B}^{PUCCH}$$

indicates the number of PRBs configured for the PUCCH.

$${N}_{symb - UCI}^{P UCCH}$$

indicates the number of symbols available for transmitting UCI on the PUCCH, and

$${N}_{sc , ctrl}^{R }$$

indicates the number or subcarriers available for transmitting UCI in a single PRB.

$${M}_{R E}^{rate - matching}$$

indicates the number of first REs, and the number of first REs is the number of REs that are associated with the uplink muting pattern and on which transmission is not performed in a symbol for transmitting uplink control information UCI on the PUCCH.

Qₘ indicates a modulation order corresponding to the PUCCH, and r indicates a code rate corresponding to the PUCCH.

The number of PRBs configured for the PUCCH may be the number of PRBs configured for the PUCCH for transmitting CSI.

In some implementations, in another embodiment B (for example, the terminal transmits HARQ-ACK, SR, and CSI on one PUCCH, and a CSI report contains a second part (part 2) of CSI); and in a case that the fifth condition is met, the second value includes the number of second parts of CSI reports transmitted on the PUCCH, and the total number of first parts of CSI reports that need to be multiplexed and transmitted on the PUCCH.

The fifth condition is at least one of the following:

$${\sum }_{n = 1}^{{N}_{CSI - part 2}^{reported}} {O}_{CSI - part 2 , n} + {O}_{CRC , CSI - part 2 , N} \leq ( {M}_{R B}^{PUCCH} \cdot {N}_{sc , ctrl}^{R B} \cdot {N}_{symb - uci}^{P UCCH} - [ ( {O}_{A C K} + {O}_{S R} + {\sum }_{n = 1}^{{N}_{CSI}^{total}} {O}_{CSI - part 1 , n} + {O}_{CRC , CSI - part 1} ) / ( {Q}_{m} \cdot r ) ] ) \cdot {Q}_{m} \cdot r ;$$

$$and$$

$${\sum }_{n = 1}^{{N}_{CSI - part 2}^{reported} + 1} {O}_{CSI - part 2 , n} + {O}_{CRC , CSI - part 2 N , + 1} > ( {M}_{R B}^{PUCCH} \cdot {N}_{sc , ctrl}^{R B} \cdot {N}_{symb - uci}^{P UCCH} - [ ( {O}_{A C K} + {O}_{S R} + {\sum }_{n = 1}^{{N}_{CSI}^{total}} {O}_{CSI - part 1 , n} + {O}_{CRC , CSI - part 1} ) / ( {Q}_{m} \cdot r ) ] ) \cdot {Q}_{m} \cdot r .$$

$${N}_{CSI - part 2}^{reported}$$

indicates the number of second parts of CSI reports transmitted on the PUCCH.

O_{ACK} indicates the number of bits of HARQ-ACK information transmitted on the PUCCH, and O_{SR} indicates the number of bits of SR information transmitted on the PUCCH.

O_{CRC,CSI-part2,N} indicates the number of CRC bits corresponding to

$${O}_{A C K} + {O}_{S R} + {\sum }_{n = 1}^{{N}_{CSI}^{reported}} {O}_{CSI - part 2 , n} ,$$

where O_{CSI-part2,n} indicates the number of bits of the second part of the n-th CSI report.

O_{CRC,CSI-part2,N+1} indicates the number of CRC bits corresponding to

$${O}_{A C K} + {O}_{S R} + {\sum }_{n = 1}^{{N}_{CSI}^{reported} + 1} {O}_{CSI - part 2 , n} ,$$

where O_{CSI-part2,n} indicates the number of bits of the second part of the n-th CSI report.

O_{CRC,CSI-part1,N} indicates the number of CRC bits corresponding to

$${O}_{A C K} + {O}_{S R} + {\sum }_{n = 1}^{{N}_{CSI}^{reported}} {O}_{CSI - part 1 , n} ,$$

where O_{CSI-part1,n} indicates the number of bits of the first part of the n-th CSI report.

$${N}_{CSI}^{total}$$

indicates the total number of CSI reports that need to be multiplexed and transmitted on the PUCCH.

$${M}_{R B}^{PUCCH}$$

indicates the total number of CSI reports that need to be multiplexed and transmitted on the PUCCH.

$${N}_{symb - UCI}^{P UCCH}$$

indicates the number of symbols available for transmitting UCI on the PUCCH, and

$${N}_{sc , ctrl}^{R B}$$

indicates the number or subcarriers available for transmitting UCI in a single PRB.

Qₘ indicates a modulation order corresponding to the PUCCH, and r indicates a code rate corresponding to the PUCCH.

In some implementations, in another embodiment (if the terminal transmits HARQ-ACK, SR, and CSI on one PUCCH, where a CSI includes CSI part 1 and CSI part 2, but if the condition is not met according to the foregoing embodiment B, the UE discards all CSI parts 2, and determines the number of CSI parts 1 for transmission in the following manner), in a case that the fifth condition is not met, the second value is equal to the number of first parts of CSI reports transmitted on the PUCCH and meeting a sixth condition.

The sixth condition includes at least one of the following:

$$( {O}_{A C K} + {O}_{S R} + {\sum }_{n = 1}^{{N}_{CSI - part 1}^{reported}} {O}_{C S I - part 1 , n} + {O}_{C R C , C S I - part 1 , N + 1} ) \} \leq {M}_{R B}^{P U C C H} \cdot {N}_{s c , ctrl}^{R B} \cdot {N}_{s ymb \cdot UCI}^{P U C C H} \cdot {Q}_{m} \cdot r ; and ( {O}_{A C K} + {O}_{S R} + {\sum }_{n = 1}^{{N}_{CSI - part 1}^{reported}} {O}_{C S I - part 1 , n} + {O}_{C R C , C S I - part 1 , N + 1} ) \} > {M}_{R B}^{P U C C H} \cdot {N}_{s c , ctrl}^{R B} \cdot {N}_{s ymb \cdot UCI}^{P U C C H} \cdot {Q}_{m} \cdot r . {N}_{CSI - part 1}^{reported}$$

indicates the number of first parts of CSI reports transmitted on the PUCCH.

O_{ACK} indicates the number of bits of HARQ-ACK information transmitted on the PUCCH, and O_{SR} indicates the number of bits of SR information transmitted on the PUCCH.

O_{CRC,CSI-part1,N} indicates the number of CRC bits corresponding to

$${O}_{ACK} + {O}_{SR} + {Σ}_{n = 1}^{{N}_{CSI}^{reported} + 1} {O}_{CSI - part 1 , n} ,$$

where O_{CSI-part1,n} indicates the number of bits of the first part of the n-th CSI report.

O_{CRC,CSI-part1,N+1} indicates the number of CRC bits corresponding to

$${O}_{ACK} + {O}_{SR} + {Σ}_{n = 1}^{{N}_{CSI}^{reported} + 1} {O}_{CSI - part 1 , n} .$$

indicates the total number of CSI reports that need to be multiplexed and transmitted on the PUCCH.

$${M}_{R B}^{P U C C H}$$

indicates the number of PRBs configured for the PUCCH.

$${N}_{symb - UCI}^{P UCCH}$$

indicates the number of symbols available for transmitting UCI on the PUCCH, and

$${N}_{sc , ctrl}^{RB }$$

indicates the number of subcarriers available for transmitting UCI in a single PRB.

Qₘ indicates a modulation order corresponding to the PUCCH, and r indicates a code rate corresponding to the PUCCH.

In addition, for the third condition, the number of PRBs configured for the PUCCH may be the number of PRBs configured for the PUCCH in a PUCCH resource with an index of 0; and for the fourth condition, the number of PRBs configured for the PUCCH may be the number of PRBs configured for the PUCCH in a PUCCH resource with an index of j+1. In a case that the third condition is not met and the fourth condition is not met, the number of PRBs configured for the PUCCH may be the number of PRBs configured for the PUCCH in a PUCCH resource with an index of J−1.

In this implementation, the determined number of CSI reports transmitted on the PUCCH can be made more reasonable by using at least one formula above, so as to improve the transmission performance of the PUCCH.

In some implementations, the uplink muting pattern is applicable to at least one of the following:
a dynamically scheduled PUSCH;
a configured grant PUSCH; and
a PUCCH.

A CRC in a downlink control information DCI format of the dynamically scheduled PUSCH is scrambled by at least one of the following:
a C-RNTI;
an MCS-C-RNTI; and
a CS-RNTI.

The PUCCH format of the PUCCH may be PUCCH format 2 or PUCCH format 3 specified by the protocol.

In this implementation, using the uplink muting pattern for a specific PUSCH and PUCCH is implemented, so as to improve the transmission performance of the uplink channels.

In some implementations, the uplink muting pattern is not used for a PUSCH scheduled by using a Random Access Response (RAR) uplink grant (UL grant) or a fallback (fallback) RAR UL grant, or for message A (MsgA) PUSCH, or the number of first REs is set to 0. These PUSCHs do not need to perform uplink rate matching based on an uplink muting pattern configured or indicated by the network side, or the uplink muting patterns of these PUSCHs or the number of first REs can be configured by system information, such as System Information Block (SIB)1.

In some implementations, a resource that is indicated by the uplink muting pattern and on which transmission is not performed does not overlap a symbol or an RE in which a DMRS of the uplink channel is located; or
a resource that is indicated by the uplink muting pattern and on which transmission is not performed does not overlap an RE in which a Phase-Tracking Reference Signal (PTRS) of the PUSCH is located; or
the terminal does not expect a resource that is indicated by the uplink muting pattern and on which transmission is not performed to overlap a symbol or an RE in which a DMRS of the uplink channel is located; or
   the terminal does not expect a resource that is indicated by the uplink muting pattern and on which transmission is not performed to overlap an RE in which a phase tracking reference signal PTRS of the PUSCH is located.

In this implementation, it can be implemented that the resource that is indicated by the uplink muting pattern and on which transmission is not performed does not overlap a resource in which a DMRS or PTRS is located, so as to avoid that the terminal cannot perform DMRS or PTRS transmission, thereby improving transmission performance of the terminal.

The not expecting may be that if the resource that is indicated by the uplink muting pattern and on which transmission is not performed overlaps the symbol or RE in which the DMRS of the uplink channel is located, the terminal ignores or discards the uplink muting pattern, or ignores a resource indicated by the uplink muting pattern and overlapping a symbol or an RE in which the DMRS of the uplink channel is located;

In some implementations, the not expecting may be that if the resource that is indicated by the uplink muting pattern and on which transmission is not performed overlaps an RE in which a phase tracking reference signal PTRS of the PUSCH is located, the terminal ignores or discards the uplink muting pattern, or ignores a resource indicated by the uplink muting pattern and overlapping an RE in which the phase tracking reference signal PTRS of the PUSCH is located.

In some implementations, the configuration information is higher-layer signaling configuration information; or
in a case that the terminal obtains an uplink muting pattern configured by using layer 1 (L1) or layer 2 (L2) signaling, the terminal does not use the uplink muting pattern configured by using layer 1 or layer 2 signaling during calculation of a TBS of the uplink channel.

In this implementation, it can be implemented that the uplink muting pattern is configured by using higher-layer signaling, for example, being configured by using system information and being configured by using higher-layer RRC.

In addition, it can be further implemented that if L1 or L2 signaling indicates an uplink muting pattern, the uplink muting pattern indicated by the L1 or L2 signaling is not considered during calculation of the TBS, so as to avoid that the uplink muting pattern indicated by the L1 or L2 signaling is not applicable to the calculation of the TBS of the uplink channel, which further helps improve the transmission reliability of the uplink channel.

In some implementations, the number of first REs is determined based on the uplink muting pattern, or the number of first REs is configured by a higher layer.

The number of first REs being determined based on the uplink muting pattern may be calculating the number of first REs based on the uplink muting pattern, not requiring additional signaling configuration, thereby reducing signaling overheads.

The number of first REs being configured by the higher layer may be that the network-side device configures the number of first REs by using higher-layer signaling.

In some implementations, in a case that the UCI is multiplexed and transmitted on the PUSCH, the resources that are indicated by the uplink muting pattern and on which transmission is not performed are skipped for UCI mapping.

The UCI may include at least one of the following:
HARQ-ACK, SR, CSI, Configured Grant (CG)-UCI, and Unused Transmission Occasion (UTO)-UCI, where the UTO-UCI can be used to indicate a CG PUSCH transmission occasion that is not used by the terminal.

Skipping the resource that is indicated by the uplink muting pattern and on which transmission is not performed may be removing the resource that is indicated by the uplink muting pattern and on which transmission is not performed in the PUSCH resource.

In this implementation, it can be implemented that the UCI is not transmitted on the resource indicated by the uplink muting pattern, so as to avoid or reduce interference.

In some implementations, in a case that the effective channel code rate of the uplink channel is greater than a preset threshold, the terminal does not transmit the uplink channel; or the terminal does not expect the effective channel code rate of the uplink channel to be greater than the preset threshold.

The effective channel code rate of the uplink channel is calculated based on the number of first REs, for example, the number of uplink information bits (including CRC bits) of the uplink channel is calculated based on the number of first REs, and the effective channel code rate is obtained by dividing the number of uplink information bits by the number of physical channel bits on the PUSCH. The effective channel code rate is defined as the number of uplink information bits (including CRC bits) divided by the number of physical channel bits on the PUSCH. For example, the effective channel code rate=TBS including CRC and determined above/TBS transmissible for all available REs for UL-SCH transmission on the PUSCH.

The preset threshold can be specified by the protocol or configured by the network side, for example, the threshold is related to a channel type or channel coding mode.

In this implementation, in a case that the effective channel code rate of the uplink channel is greater than a preset threshold, the terminal does not transmit the uplink channel; or the terminal does not expect the effective channel code rate of the uplink channel to be greater than the preset threshold. In this way, it can avoid errors in transmission of the uplink channel, which helps improve the transmission reliability of the uplink channel.

In some implementations, if the TBS of PUSCH transmission is determined in a manner defined by the protocol (not based on the number of first REs), the terminal does not transmit the PUSCH when the effective channel code rate corresponding to the PUSCH is greater than a specific value (the value can be predefined or configured by the network side), or for the CG PUSCH, when the effective channel code rate corresponding to the PUSCH is greater than a specific value, the terminal does not transmit the PUSCH. For Dynamic Grant (DG) PUSCH (or the 1st effective PUSCH when multiple PUSCHs are scheduled by using a single DCI), the terminal does not expect the effective channel code rate corresponding to the PUSCH to be greater than a specific value. The effective channel code rate is defined as the number of uplink information bits (including CRC bits) divided by the number of physical channel bits on the PUSCH.

In addition, the determining may be performed per repetition (per repetition) or per repetition bundle (per repetition bundle) (all PUSCHs for repeated transmission).

The determining performed per repetition may be determining performed for each repeated transmission, no transmission is performed for that meeting the above condition, and transmission performed for that not meeting the above condition.

The determining performed per repetition bundle may be that when one PUSCH of all PUSCHs for repeated transmission meets the above condition, no transmission is performed for all the PUSCHs.

In some implementations, in a case that the resource, the number of PRBs, or the number of CSI reports during transmission of the PUCCH is determined in a manner defined by the protocol (not based on the number of first REs), when the effective channel code rate corresponding to the PUCCH is greater than a specific value (the value may be predefined or configured by the network side), the terminal does not transmit the PUCCH, or the terminal does not expect the effective channel code rate corresponding to the PUCCH to be greater than the specific value.

In some implementations, the method further includes:
the terminal sends the uplink channel based on the transmission information of the uplink channel.

In this embodiment of this application, the terminal obtains configuration information, where the configuration information is used for configuring an uplink muting pattern, and the uplink muting pattern is used for indicating resources on which transmission is not performed; and the terminal determines transmission information of an uplink channel based on the number of first resource elements REs, where the number of first REs is the number of REs that are associated with the uplink muting pattern and on which transmission is not performed, and the uplink channel includes at least one of the following: a PUSCH and a PUCCH. In this way, the transmission information of the uplink channel can be determined in a case that the uplink muting pattern is configured, and then transmission of the uplink channel transmission can be supported in a case that the uplink muting pattern is configured, so as to improve the transmission performance of the terminal.

Referring to FIG. 4, FIG. 4 is a flowchart of a configuration information sending method according to an embodiment of this application. As shown in FIG. 4, the method includes the following steps.

Step 401: A network-side device sends configuration information to a terminal, where the configuration information is used for configuring an uplink muting pattern, and the uplink muting pattern is used for indicating resources on which transmission is not performed.

In some implementations, the uplink muting pattern is applicable to at least one of the following:
a dynamically scheduled PUSCH;
a configured grant PUSCH; and
a PUCCH.

In some implementations, a CRC in a downlink control information DCI format of the dynamically scheduled PUSCH is scrambled by at least one of the following:
a cell-radio network temporary identifier C-RNTI;
a modulation and coding scheme cell-radio network temporary identifier MCS-C-RNTI; and
a configured scheduling radio network temporary identifier CS-RNTI.

In some implementations, a resource that is indicated by the uplink muting pattern and on which transmission is not performed does not overlap a symbol or an RE in which a DMRS of the uplink channel is located; or
a resource that is indicated by the uplink muting pattern and on which transmission is not performed does not overlap an RE in which a phase tracking reference signal PTRS of a PUSCH is located.

In some implementations, the configuration information is higher-layer signaling configuration information.

It should be noted that this embodiment is an implementation of a network-side device corresponding to the embodiment shown in FIG. 2. For the specific implementation, reference may be made to the related description of the embodiment shown in FIG. 2. To avoid repeated descriptions, details are not repeated in this embodiment.

The following describes the method provided in the embodiments of this application by using a plurality of embodiments as examples.

### Embodiment 1

When UCI is multiplexed onto the PUSCH, the terminal calculates the number of REs for the UCI on the PUSCH, where the number of REs of the UCI on the PUSCH is related to the number of REs available on the PUSCH. In this embodiment, the terminal considers the uplink muting pattern when determining the number of REs available on the PUSCH, and removes an RE (including an RB) that is indicated by the uplink muting pattern and on which transmission is not performed in the PUSCH resource allocation. For example, when HARQ-ACK is transmitted on the PUSCH, if the PUSCH does not use repetition type B (repetition type B) and the number of slots (numberOfSlotsTBoMS) for multi-slot common transmission of a transport block is configured, or numberOfSlotsTBoMS is configured and the number of lines indicated by time domain resource allocation (time domain resource allocation, TDRA) in DCI is 1, the number of coded modulation symbols QACK on each layer for HARQ-ACK transmission on the PUSCH is calculated in the following manner

$${Q}_{ACK}^{{′}^{}} = min ‖ \{ ⌈ \frac{( {O}_{A C K} + {L}_{A C K} ) \cdot {β}_{o f f s e t}^{PUSCH} \cdot {\sum }_{l = 0}^{{N}_{s y m b , all}^{PUSCH} - 1} {M}_{s c}^{UCI} ( l )}{{\sum }_{r = 0}^{{C}_{UL - S C H} - 1} {K}_{r}} ⌉ , ⌈ α . {\sum }_{l = {l}_{0}}^{{N}_{s y m b , all}^{PUSCH} - 1} {M}_{s c}^{UCI} ( l ) ⌉ \} ,$$

where
O_{ACK} indicates the number of bits of HARQ-ACK.

If O_{ACK}≥360, L_{ACK}=11; otherwise, L_{ACK} indicates the number of CRC bits corresponding to HARQ-ACK.

$${β}_{offset}^{PUSCH} = {β}_{offset}^{H ARQ - ACK}$$

indicates an offset value for calculating an RE used for HARQ-ACK when HARQ-ACK is transmitted on the PUSCH.

C_{UL-SCH} indicates the number of code blocks for transmitting UL-SCH on the PUSCH; if a DCI format for scheduling transmission of the PUSCH includes a Code Block Group Transmission Information (CBGTI) field, and indicates that the terminal does not transmit the r-th code block, Kᵣ=0; otherwise, Kᵣ indicates a size of the r-th code block of UL-SCH transmitted on the PUSCH.

$${M}_{s c}^{UCI} ( l )$$

indicates the number of REs available for UCI in the PUSCH transmission symbol l, where

$$l = 0 , 1 , 2 , … , {N}_{s y mb , all}^{PUSCH} - 1. {N}_{s ymb , all}^{PUSCH}$$

indicates the total number of Orthogonal Frequency Division Multiplex (OFDM) symbols including DMR symbols in the PUSCH.

For OFDM symbols on the PUSCH with DMRS,

$${M}_{s c}^{UCI} ( l ) = 0 .$$

For OFDM symbols on the PUSCH without DMRS,

$${M}_{s c}^{UCI} ( l )$$

is as follows.

$${M}_{s c}^{UCI} ( l ) = {M}_{s c}^{PUSCH} - {M}_{s c}^{P T - R S} ( l ) - {M}_{SC}^{rate - matching} ;$$

indicates a scheduling bandwidth corresponding to transmission of the PUSCH (indicating the number of subcarriers).

$${M}_{s c}^{PT - RS} ( l )$$

indicates the number of subcarriers carrying PTRS in the PUSCH transmission symbol l.

$${M}_{SC}^{rate - matching} ( l )$$

indicates the number of subcarriers or REs that are indicated by the uplink muting pattern and on which transmission is not performed in the PUSCH transmission symbol l.

α indicates a parameter configured by RRC, such as a scaling parameter (scaling).

l₀ indicates an index of the 1st OFDM symbol not including DMRS after the 1st DMRS for transmission of the PUSCH.

In this embodiment, when the UCI is multiplexed onto the PUSCH, the UE needs to skip an RE in which the uplink rate matching/muting pattern is located when mapping the UCI to the RE.

### Embodiment 2

In this embodiment, if the terminal transmits HARQ-ACK information of O_{ACK} bits on one PUCCH format 2/3, and if the number of CRC bits corresponding to HARQ-ACK information of O_{ACK} bits transmitted by the UE on one PUCCH format 2/3 is O_{CRC}, the PUCCH includes

$${M}_{RB}^{PUCCH}$$

PRBs, the UL determines, based on the following, PRBs for transmission of the PUCCH.

$${M}_{RB , min}^{PUCCH} :$$

(less than and equal to the number of configured PRBS

$${M}_{RB}^{PUCCH} )$$

indicates a minimum number of PRBs meeting

$$( {O}_{ACK} + {O}_{CRC} ) \leq ( {M}_{RB , min}^{PUCCH} \cdot {N}_{sc , ctrl}^{RB} \cdot {N}_{symb - UCI}^{PUCCH} - {M}_{RE}^{rate - matchig} ) \cdot {Q}_{m} \cdot r and$$

$$( {O}_{ACK} + {O}_{CRC} ) > [ ( {M}_{RB , min}^{PUCCH} - 1 ) \cdot {N}_{sc , ctrl}^{RB} \cdot {N}_{symb - UCI}^{PUCCH} - {M}_{RE}^{rate - matchig} ] \cdot {Q}_{m} \cdot r ;$$

$${N}_{symb - UCI}^{PUCCH}$$

indicates the number of symbols available for transmitting UCI on the PUCCH

$${N}_{sc , ctrl}^{RB}$$

indicates the number of subcarriers available for transmitting UCI in a single PRB, Qₘ indicates a modulation order corresponding to the PUCCH, r indicates a code rate corresponding to the PUCCH, and

$${M}_{RE}^{rate - matchig}$$

indicates the number or REs that are indicated by the uplink muting pattern and on which transmission is not performed within a symbol for transmitting UCI on the PUCCH.

For the PUCCH format 3, due to a discrete fourier transform (Discrete Fourier Transform, DFT) limitation,

$${M}_{RB , min}^{PUCCH} = {2}^{{α}_{2}} \cdot {3}^{{α}_{3}} \cdot {5}^{{α}_{5}}$$

needs to be further met; otherwise,

$${M}_{RB , min}^{PUCCH}$$

is increased to a nearest value, where α₂, α₃, and α₅ are non-negative integers.

If

$$( {O}_{ACK} + {O}_{CRC} ) > ( {M}_{RB , min}^{PUCCH} - 1 ) \cdot {N}_{sc , ctrl}^{RB} \cdot {N}_{symb - UCI}^{PUCCH} \cdot {Q}_{m} \cdot r ,$$

the UE perform PUCCH transmission in

$${M}_{RB}^{PUCCH}$$

### PRBs.

In addition, the CSI report can be transmitted on the PUCCH, and the network-side device can configure the terminal to upload one CSI report on one PUCCH. In some cases, the terminal needs to upload multiple CSI reports on one PUCCH, for example, when PUCCH resources of multiple CSIs overlap, or the number of PUCCHs in one slot is greater than a specified number (for example, 2). In this case, there may be HARQ-ACK information or SR information on the PUCCH. If the terminal transmits all UCIs on one PUCCH (the PUCCH resource is determined based on the number of bits of the UCI), the code rate of UCI may be too great. Therefore, a discarding principle for CSI being transmitted on the PUCCH may be defined.

For example, when the UE multiplexes UCI information including CSI onto the J PUCCH resources configured by the multi-CSI-PUCCH-ResourceList (J<=2), resource indexes of the J resources are numbered in ascending order of products of the corresponding number of REs, a modulation order Qₘ, and a configured code rate r.

If

$$( {O}_{ACK} + {O}_{SR} + {O}_{CSI} + {O}_{CRC} ) \leq {[ ( {M}_{PRB}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r ]}_{0} ,$$

the UE uses a PUCCH resource with an index of 0 (namely, resource 0);
otherwise,
if

$$( {O}_{ACK} + {O}_{SR} + {O}_{CSI} + {O}_{CRC} ) > {[ ( {M}_{PRB}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r ]}_{j} , and$$

$$( {O}_{ACK} + {O}_{SR} + {O}_{CSI} + {O}_{CRC} ) \leq {[ ( {M}_{PRB}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r ]}_{j + 1} {,}^{0 \leq j < J - 1} .$$

The terminal transmits the HARQ-ACK, SR, and CSI reports using the PUCCH resource with an index of j+1 (namely, resource j+1).

Otherwise, the terminal uses a PUCCH resource with an index of J-1 (namely, resource J−1), and the UE selects

$${N}_{CSI}^{reported}$$

CSI reports in an ascending order of priority values (priority value) corresponding to CSI, for transmission along with HARQ-ACK and SR. A principle of selecting CSI by the terminal is based on a maximum number of CSI reports whose transmission code rate is not greater than a configured code rate r. Details are described below.

For example, when UE multiplexes UCI information containing CSI onto a PUCCH resource indicated by DCI corresponding to HARQ-ACK, the UE determines the PUCCH resource, the number of PRBs and the number of CSI reports for transmission based on the following.

The UE determines a corresponding PUCCH resource set (PUCCH resource set) based on the number of bits O_{UCI} of UCI for transmission and determines a corresponding PUCCH resource in the PUCCH resource set based on a PUCCH Resource Indicator (PRI) indicated by DCI corresponding to HARQ-ACK.

On the determined resource, the number of PRBs used or CSI reports during PUCCH transmission by using the following method.

If

$$( {O}_{ACK} + {O}_{SR} + {O}_{CSI} + {O}_{CRC} ) \leq ( {M}_{PRB}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r ,$$

the UE selects, from

$${M}_{RB}^{PUCCH}$$

PRBs configured for the PUCCH, a minimum number

$${M}_{RB , min}^{PUCCH}$$

of PRBs, meeting

$$( {O}_{ACK} + {O}_{SR} + {O}_{CSI} + {O}_{CRC} ) \leq ( {M}_{PRB , min}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r ,$$

so as to transmit HARQ-ACK, SR, and CSI report.

Otherwise, the UE selects, from all CSI reports (namely,

$${N}_{CSI}^{total}$$

CSI reports),

$${N}_{CSI}^{reported}$$

CSI reports in ascending order of priority values, for transmission along with HARQ-ACK and SR, where

$${N}_{CSI}^{reported}$$

meets the following:

$$( {O}_{ACK} + {O}_{SR} + {\sum }_{n = 1}^{{N}_{CSI}^{reported}} {O}_{CSI - part 1 , n} + {O}_{CRC , CSI - part 1 , N} ) \leq ( {M}_{PRB}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r ;$$

$$( {O}_{ACK} + {O}_{SR} + {\sum }_{n = 1}^{{N}_{CSI}^{reported}} {O}_{CSI - part 1 , n} + {O}_{CRC , CSI - part 1 , N} ) \leq {M}_{RB}^{PUCCH} \cdot {N}_{sc , ctrl}^{RB} \cdot {N}_{symb - UCI}^{PUCCH} \cdot {Q}_{m} \cdot r , and$$

$$( {O}_{ACK} + {O}_{SR} + {\sum }_{n = 1}^{{N}_{CSI}^{reported} + 1} {O}_{CSI - part 1 , n} + {O}_{CRC , CSI - part 1 , N} ) > ( {M}_{PRB}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r .$$

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

O_{CRC,CSI-part1,N+1} indicates the number of CRC bits corresponding to

$${O}_{ACK} + {O}_{SR} + {\sum }_{n = 1}^{{N}_{CSI}^{reported} + 1} {O}_{CSI - part 1 , n} ,$$

and O_{CSI-part1,n} indicates the number of bits of the first part of the n-th CSI report.

In some implementations, in another embodiment (for example, the terminal transmits HARQ-ACK, SR, and CSI on one PUCCH, and a CSI report contains a second part (part 2) of CSI); and in a case that the fifth condition is met, the number of CSI reports transmitted on the PUCCH includes the number of second parts of CSI reports transmitted on the PUCCH, and the total number of first parts of CSI reports that need to be multiplexed and transmitted on the PUCCH.

The fifth condition is at least one of the following:

$${\sum }_{n = 1}^{{N}_{CSI - part 2}^{reported}} {O}_{CSI - part 2 , n} + {O}_{CRC , CSI - part 2 , N} \leq ( {M}_{PRB}^{PUCCH} \cdot {N}_{sc , ctrl}^{RB} \cdot {N}_{symb - uci}^{PUCCH} - [ ( {O}_{ACK} + {O}_{SR} + {\sum }_{n = 1}^{{N}_{CSI}^{total}} {O}_{CSI - part 1 , n} + {O}_{CRC , CSI - part 1} ) / ( {Q}_{m} \cdot r ) ] ) \cdot {Q}_{m} \cdot r ; and$$

$${\sum }_{n = 1}^{{N}_{CSI - part 2}^{reported} + 1} {O}_{CSI - part 2 , n} + {O}_{CRC , CSI - part 2 , N + 1} > ( {M}_{RB}^{PUCCH} \cdot {N}_{sc , ctrl}^{RB} \cdot {N}_{symb - uci}^{PUCCH} - [ ( {O}_{ACK} + {O}_{SR} + {\sum }_{n = 1}^{{N}_{CSI}^{total}} {O}_{CSI - part 1 , n} + {O}_{CRC , CSI - part 1} ) / ( {Q}_{m} \cdot r ) ] ) \cdot {Q}_{m} \cdot r .$$

$${N}_{CSI - part 2}^{reported}$$

indicates the number of second parts of CSI reports transmitted on the PUCCH.

O_{ACK} indicates the number of second parts of CSI reports transmitted on the PUCCH, and O_{SR} indicates the number of bits of SR information transmitted on the PUCCH.

O_{CRC,CSI-part2,N} indicates the number of CRC bits corresponding to

$${O}_{ACK} + {O}_{SR} + {\sum }_{n = 1}^{{N}_{CSI}^{reported}} {O}_{CSI - part 2 , n} ,$$

and O_{CSI-part2,n} indicates the number of bits of the second part of the n-th CSI report.

O_{CRC,CSI-part2,N+1} indicates the number of CRC bits corresponding to

$${O}_{ACK} + {O}_{SR} + {\sum }_{n = 1}^{{N}_{CSI}^{reported} + 1} {O}_{CSI - part 2 , n} ,$$

and O_{CSI-part2,n} indicates the number of bits of the second part of the n-th CSI report.

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

where O_{CSI-part1,n} indicates the number of bits of the first part of the n-th CSI report.

$${N}_{CSI}^{total}$$

indicates the total number of CSI reports that need to be multiplexed and transmitted on the PUCCH.

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB }$$

indicates the number or subcarriers available for transmitting UCI in a single PRB.

Qₘ indicates a modulation order corresponding to the PUCCH, and r indicates a code rate corresponding to the PUCCH.

In some implementations, in another embodiment (for example, the terminal transmits HARQ-ACK, SR, and CSI on one PUCCH, where a CSI includes CSI part 1 and CSI part 2, and all CSI part 2 are discarded according to the above embodiment), if the fifth condition is not met, the number of CSI reports transmitted on the PUCCH is the number of first parts of CSI reports transmitted by the PUCCH that meets a sixth condition.

The sixth condition includes at least one of the following:

$$( {O}_{ACK} + {O}_{SR} + {\sum }_{n = 1}^{{N}_{CSI - part 1}^{reported}} {O}_{CSI - part 1 , n} + {O}_{CRC , CSI - part 1 , N} ) \leq {M}_{RB}^{PUCCH} \cdot {N}_{sc , ctrl}^{RB} \cdot {N}_{symb - UCI}^{PUCCH} \cdot {Q}_{m} \cdot r ; and$$

$$( {O}_{ACK} + {O}_{SR} + {\sum }_{n = 1}^{{N}_{CSI - part 1}^{reported} + 1} {O}_{CSI - part 1 , n} + {O}_{CRC , CSI - part 1 , N + 1} ) > {M}_{RB}^{PUCCH} \cdot {N}_{sc , ctrl}^{RB} \cdot {N}_{symb - UCI}^{PUCCH} \cdot {Q}_{m} \cdot r .$$

$${N}_{CSI - part 1}^{reported}$$

indicates the number of first parts of CSI reports transmitted on the PUCCH.

O_{ACK} indicates the number of bits of HARQ-ACK information transmitted on the PUCCH, and O_{SR} indicates the number of bits of SR information transmitted on the PUCCH.

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

where O_{CSI-part1,n} indicates the number of bits of the first part of the n-th CSI report.

O_{CRC,CSI-part1,N+1} indicates the number of CRC bits corresponding to

$${O}_{ACK} + {O}_{SR} + {\sum }_{n = 1}^{{N}_{CSI}^{reported} + 1} {O}_{CSI - part 1 , n} \cdot {N}_{CSI}^{total}$$

indicates the total number of CSI reports that need to be multiplexed and transmitted on the PUCCH.

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{R B}$$

indicates the number of subcarriers available for transmitting UCI in a single PRB.

Qₘ indicates a modulation order corresponding to the PUCCH, and r indicates a code rate corresponding to the PUCCH.

In this embodiment of this application, the following can be implemented:
the terminal determines the TBS based on the uplink muting pattern;
when the effective code rate corresponding to the PUSCH is greater than a specific value, the terminal does not transmit the PUSCH, or for the CG PUSCH, when the effective channel code rate corresponding to PUSCH is greater than a specific value, the terminal does not transmit the PUSCH, or for DG PUSCH (or the first effective PUSCH when multiple PUSCH are scheduled by a single DCI), the terminal does not expect the effective channel code rate corresponding to the PUSCH to be greater than a specific value, where the effective channel code rate is defined as the number of uplink information bits (including CRC bits) divided by the number of physical channel bits on the PUSCH;
when the UCI (such as HARQ-ACK, CG-UCI, UTO-UCI, or CSI) is multiplexed onto the PUSCH, the RE in which the uplink muting pattern is located is skipped; and
the terminal determines the transmission resource of the PUCCH, the number of PRBs for transmission of the PUCCH, or the number of CSI reports based on the uplink muting pattern.

In this embodiment of this application, when the uplink muting pattern is configured for or indicated to the terminal, the terminal determines a TBS of the PUSCH and parameter information of PUCCH transmission, which can improve the effectiveness of the communication system.

For the transmission information determining method provided in this embodiment of this application, the execution subject may be a transmission information determining apparatus. The transmission information determining apparatus provided in an embodiment of this application is described by assuming that the transmission information determining apparatus performs the transmission information determining method in the embodiments of this application.

Refer to FIG. 5. FIG. 5 is a structural diagram of a transmission information determining apparatus according to an embodiment of this application. As shown in FIG. 5, the transmission information determining apparatus 500 includes:
an obtaining module 501, configured to obtain configuration information, where the configuration information is used for configuring an uplink muting pattern, and the uplink muting pattern is used for indicating resources on which transmission is not performed; and
a determining module 502, configured to determine transmission information of an uplink channel based on the number of first resource elements REs, where the number of first REs is the number of REs that are associated with the uplink muting pattern and on which transmission is not performed, and the uplink channel includes at least one of the following:
a physical uplink shared channel PUSCH and a physical uplink control channel PUCCH.

In some implementations, the transmission information includes at least one of the following:
a transport block size TBS;
a transmission resource;
the number of physical resource blocks PRBs for transmission;
the number of channel state information CSI reports for transmission; and
an effective channel code rate.

In some implementations, the determining module 502 is configured to:
calculate, based on the number of first REs, the number of second REs allocated to the PUSCH in a single PRB, where the number of first REs is the number of REs that are associated with the uplink muting pattern and on which transmission is not performed in a single PRB; and
calculate a TBS of the PUSCH based on the number of second REs.

In some implementations, the number of second REs is a value obtained by subtracting a first value from a first product, where:
the first product is a product of the number of subcarriers contained in a single PRB and the number of symbols of the PUSCH scheduled in a single slot; and
the first value is a sum of the following three values:
a configured overhead in a serving cell configuration corresponding to the PUSCH, the number of first REs, and the number of REs occupied by a demodulation reference signal DMRS in a single PRB within an allocation period of the PUSCH.

In some implementations, the determining module 502 is configured to:
calculate the number of third REs allocated to the PUSCH in a single PRB;
calculate the total number of REs allocated to the PUSCH in a single slot based on the number of first REs, the number of third REs, and the number of PRBs allocated to the terminal, where the number of first REs is the number of REs that are associated with the uplink muting pattern and on which transmission is not performed in a PRB for transmitting the PUSCH; and
calculate a TBS of the PUSCH based on the total number of REs.

In some implementations, the total number of REs is a value obtained by subtracting the number of first REs from a second product, where:
the second product is a product of a minimum value and the number of PRBs allocated to the terminal, and the minimum value is a minimum value in the number of third REs and a preset threshold.

In some implementations, the number of PRBs for transmission includes: a minimum number of PRBs for transmission of the PUCCH, where:
a value of the minimum number of PRBs for transmission of the PUCCH is a minimum value of the number of PRBs for transmission of the PUCCH in a case that the number of PRBs for transmission of the PUCCH meets a first condition; and
the first condition is a condition including the number of first REs.

In some implementations, the first condition includes:

$$( {O}_{UCI} + {O}_{CRC} ) \leq ( {M}_{RB , min}^{PUCCH} \cdot {N}_{sc , ctrl}^{RB} \cdot {N}_{symb - UCI}^{PUCCH} - M {1}_{RE}^{rate - matchig} ) \cdot {Q}_{m} \cdot r , and$$

$$( {O}_{UCI} + {O}_{CRC} ) > [ ( {M}_{RB , min}^{PUCCH} - 1 ) \cdot {N}_{sc , ctrl}^{RB} \cdot {N}_{symb - UCI}^{PUCCH} - M {2}_{RE}^{rate - matchig} ] \cdot {Q}_{m} \cdot r ; or$$

$$( {O}_{UCI} + {O}_{CRC} ) \leq ( {M}_{RB , min}^{PUCCH} \cdot ( {N}_{sc , ctrl}^{RB} \cdot {N}_{symb - UCI}^{PUCCH} - M {3}_{RE}^{rate - matchig} ) ) \cdot {Q}_{m} \cdot r , and$$

$$( {O}_{UCI} + {O}_{CRC} ) > [ ( {M}_{RB , min}^{PUCCH} - 1 ) \cdot ( {N}_{sc , ctrl}^{RB} \cdot {N}_{symb - UCI}^{PUCCH} - M {3}_{RE}^{rate - matchig} ) ] \cdot {Q}_{m} \cdot r .$$

$$M {1}_{RE}^{rate - matchig}$$

indicates the first value of the number of first REs, and the first value is the number of REs that are associated with the uplink muting pattern and on which transmission is not performed in

$${M}_{RB , min}^{PUCCH}$$

PRBs for transmission of the PUCCH within a symbol for transmitting UCI on the PUCCH.

$$M {2}_{RE}^{rate - matchig}$$

indicates a second value of the number of first REs, and the second value is the number of REs that are associated with the uplink muting pattern and on which transmission is not performed in

$${M}_{RB , min}^{PUCCH} - 1 PRBs$$

for transmission of the PUCCH within a symbol for transmitting UCI on the PUCCH.

$$M {3}_{RE}^{rate - matchig}$$

indicates a third value of the number of first REs, and the third value is the number of REs that are associated with the uplink muting pattern and on which transmission is not performed in a single PRB within a symbol for transmitting UCI on the PUCCH.

O_{CRC} indicates the number of bits of cyclic redundancy check CRC information for transmission of the PUCCH, and O_{UCI} indicates the number of bits of UCI transmitted on the PUCCH.

$${M}_{RB , min}^{PUCCH}$$

indicates a minimum number of PRBs for transmission of the PUCCH.

$${N}_{symb - UCI}^{PUCCH}$$

indicates the number of symbols available for transmitting UCI on the PUCCH, and

$${N}_{sc , ctrl}^{RB }$$

indicates the number of subcarriers available for transmitting UCI in a single PRB.

Qₘ indicates a modulation order corresponding to the PUCCH, and r indicates a code rate corresponding to the PUCCH.

In some implementations, the number of CSI reports for transmission includes the number of CSI reports transmitted on the PUCCH, where:
in a case that a second condition is met, the number of CSI reports transmitted on the PUCCH is the total number of CSI reports that need to be multiplexed and transmitted on the PUCCH; or
in a case that the second condition is not met, the number of CSI reports transmitted on the PUCCH is a second value, and the CSI reports transmitted on the PUCCH are a second-value number of CSI reports selected in ascending order of priority values in CSI reports to be multiplexed and transmitted on the PUCCH, where the second value is a maximum number of CSI reports determined in a case that a transmission code rate is not greater than a configured code rate; where
the second condition is a condition including the number of first REs.

In some implementations, the second condition includes:

$$( {O}_{UCI} + {O}_{CRC} ) \leq ( {M}_{PRB}^{PUCCH} \cdot {N}_{sc , ctrl}^{RB } \cdot {N}_{symb - uci}^{PUCCH} - M {4}_{RE}^{rate - matchig} ) \cdot {Q}_{m} \cdot r ; or$$

$$( {O}_{UCI} + {O}_{CRC} ) \leq ( {M}_{PRB}^{PUCCH} \cdot ( {N}_{sc , ctrl}^{RB } \cdot {N}_{symb - uci}^{PUCCH} - M {5}_{RE}^{rate - matchig} ) ) \cdot {Q}_{m} \cdot r .$$

$$M {4}_{RE}^{rate - matchig}$$

indicates a fourth value of the number of first REs, where the fourth value is the number of REs that are associated with the uplink muting pattern and on which transmission is not performed in

$${M}_{PRB}^{PUCCH}$$

PRBs within a symbol for transmitting UCI on the PUCCH.

$$M {5}_{RE}^{rate - matchig}$$

indicates a fifth value of the number of first REs, where the fifth value is the number of REs that are associated with the uplink muting pattern and on which transmission is not performed in a single PRB within a symbol for transmitting UCI on the PUCCH.

O_{CRC} indicates the number of bits of cyclic redundancy check CRC information for transmission of the PUCCH, and O_{UCI} indicates the number of bits of UCI transmitted on the PUCCH.

$${M}_{PRB}^{PUCCH}$$

indicates the number of PRBs configured for the PUCCH.

$${N}_{symb - UCI}^{PUCC}$$

indicates the number of symbols available for transmitting UCI on the PUCCH, and

$${N}_{sc , ctrl}^{RB }$$

indicates the number of subcarriers available for transmitting UCI in a single PRB.

Qₘ indicates a modulation order corresponding to the PUCCH, and r indicates a code rate corresponding to the PUCCH.

In some implementations, the transmission resource includes a transmission resource of the PUCCH, where:
the transmission resource of the PUCCH includes a resource selected on J PUCCH resources in at least one of the following manners:
in a case that a third condition is met, selecting a PUCCH resource with an index of 0 from the J PUCCH resources, where the third condition is a condition including the number of first REs, and J is a positive integer,
in a case that the third condition is not met and the fourth condition is met, selecting a PUCCH resource with an index of j+1 from the J PUCCH resources, where the fourth condition is a condition including the number of first REs, and 0≤j<J−1, and
in a case that the third condition is not met and the fourth condition is not met, selecting a PUCCH resource with an index of J−1 from the J PUCCH resources; where
the J PUCCH resources are PUCCH resources used for transmitting multiple CSIs, and resource indexes of the J PUCCH resources are numbered in ascending order of products of the corresponding number of REs, a modulation order and a configured code rate.

In some implementations, the third condition includes:

$$( {O}_{UCI} + {O}_{CRC} ) \leq {[ ( {M}_{PRB}^{PUCCH} \cdot {N}_{sc , ctrl}^{RB } \cdot {N}_{symb - uci}^{PUCCH} - M {6}_{RE}^{rate - matchig} ) \cdot {Q}_{m} \cdot r ]}_{0} ; or$$

$$( {O}_{UCI} + {O}_{CRC} ) \leq {[ ( {M}_{PRB}^{PUCCH} \cdot ( {N}_{sc , ctrl}^{RB } \cdot {N}_{symb - uci}^{PUCCH} - M {7}_{RE}^{rate - matchig} ) ) \cdot {Q}_{m} \cdot r ]}_{0} .$$

The fourth condition includes:

$$( {O}_{UCI} + {O}_{CRC} ) > {[ ( {M}_{PRB}^{PUCCH} \cdot {N}_{sc , ctrl}^{RB } \cdot {N}_{symb - uci}^{PUCCH} - M {6}_{RE}^{rate - matchig} ) \cdot {Q}_{m} \cdot r ]}_{j} , and$$

$$( {O}_{UCI} + {O}_{CRC} ) \leq {[ ( {M}_{PRB}^{PUCCH} \cdot {N}_{sc , ctrl}^{RB } \cdot {N}_{symb - uci}^{PUCCH} - M {6}_{RE}^{rate - matchig} ) \cdot {Q}_{m} \cdot r ]}_{j + 1} , 0 \leq j < J - 1 ; or$$

$$( {O}_{UCI} + {O}_{CRC} ) > {[ ( {M}_{PRB}^{PUCCH} \cdot ( {N}_{sc , ctrl}^{RB } \cdot {N}_{symb - uci}^{PUCCH} - M {7}_{RE}^{rate - matchig} ) ) \cdot {Q}_{m} \cdot r ]}_{j} , and$$

$$( {O}_{UCI} + {O}_{CRC} ) \leq {[ ( {M}_{PRB}^{PUCCH} \cdot ( {N}_{sc , ctrl}^{RB } \cdot {N}_{symb - uci}^{PUCCH} - M {7}_{RE}^{rate - matchig} ) ) \cdot {Q}_{m} \cdot r ]}_{j + 1} , where$$

$$0 \leq j < J - 1.$$

$$M {6}_{RE}^{rate - matchig}$$

indicates a sixth value of the number of first REs, and the sixth value is the number of REs that are associated with the uplink muting pattern and on which transmission is not performed within a symbol for transmitting UCI on the PUCCH.

$$M {7}_{RE}^{rate - matchig}$$

indicates a seven value of the number of first REs, and the seventh value is the number of REs that are associated with the uplink muting pattern and on which transmission is not performed in a single PRB within a symbol for transmitting UCI on the PUCCH.

O_{CRC} indicates the number of bits of cyclic redundancy check CRC information for transmission of the PUCCH, and O_{UCI} indicates the number of bits of UCI transmitted on the PUCCH.

$${M}_{PRB}^{PUCCH}$$

indicates the number of PRBs configured for the PUCCH.

$${N}_{symb - UCI}^{PUCC}$$

indicates the number of symbols available for transmitting UCI on the PUCCH, and

$${N}_{sc , ctrl}^{RB }$$

indicates the number of subcarriers available for transmitting UCI in a single PRB.

Qₘ indicates a modulation order corresponding to the PUCCH, and r indicates a code rate corresponding to the PUCCH.

[ ]₀ indicates calculating an operation within [ ] by using information of the PUCCH resource with the index of 0, [ ]ⱼ indicates calculating an operation within [ ] by using information of the PUCCH resource with the index of j, and [ ]ⱼ₊₁ indicates calculating an operation within [ ] by using information of the PUCCH resource with the index of j+1.

In some implementations, the number of CSI reports for transmission includes the number of CSI reports transmitted on the PUCCH, where
in a case that the third condition is met, the number of CSI reports transmitted on the PUCCH is the total number of CSI reports that need to be multiplexed and transmitted on the PUCCH; or
in a case that the third condition is not met and the fourth condition is met, the number of CSI reports transmitted on the PUCCH is the total number of CSI reports that need to be multiplexed and transmitted on the PUCCH; or
in a case that the third condition is not met and the fourth condition is not met, the number of CSI reports transmitted on the PUCCH is a second value, and the CSI reports transmitted on the PUCCH are a second-value number of CSI reports selected in ascending order of priority values in CSI reports to be multiplexed and transmitted on the PUCCH, where the second value is a maximum number of CSI reports determined in a case that a transmission code rate is not greater than a configured code rate.

In some implementations, the second value meets at least one of the following conditions:

$$( {O}_{ACK} + {O}_{SR} + {\sum }_{n = 1}^{{N}_{CSI}^{reported}} {O}_{CSI - part 1 , n} + {O}_{CRC , CSI - part 1 , N} ) \leq ( {M}_{PRB}^{PUCCH} \cdot {N}_{sc , ctrl}^{RB } \cdot {N}_{symb - uci}^{PUCCH} - {M}_{RE}^{rate - matchig} ) \cdot {Q}_{m} \cdot r ;$$

$$( {O}_{ACK} + {O}_{SR} + {\sum }_{n = 1}^{{N}_{CSI}^{reported}} {O}_{CSI - part 1 , n} + {O}_{CRC , CSI - part 1 , N} ) \leq {M}_{PRB}^{PUCCH} \cdot {N}_{sc , ctrl}^{RB } \cdot {N}_{symb - UCI}^{PUCCH} \cdot {Q}_{m} \cdot r ; and$$

$$( {O}_{ACK} + {O}_{SR} + {\sum }_{n = 1}^{{N}_{CSI}^{reported} + 1} {O}_{CSI - part 1 , n} + {O}_{CRC , CSI - part 1 , N} ) > ( {M}_{PRB}^{PUCCH} \cdot {N}_{sc , ctrl}^{RB } \cdot {N}_{symb - uci}^{PUCCH} - {M}_{RE}^{rate - matchig} ) \cdot {Q}_{m} \cdot r .$$

$${N}_{CSI}^{reported}$$

indicates the second value, O_{ACK} indicates the number of bits of HARQ-ACK information transmitted on the PUCCH, and O_{SR} indicates the number of bits of SR information transmitted on the PUCCH.

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

where O_{CSI-part1,n} indicates the number of bits of the first part of the n-th CSI report.

$${M}_{PRB}^{PUCCH}$$

indicates the number of PRBs configured for the PUCCH, and

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB}$$

indicates the number of subcarriers available for transmitting UCI in a single PRB.

$${M}_{RE}^{rate - matchig}$$

indicates the number of first REs, and the number of first REs is the number of REs that are associated with the uplink muting pattern and on which transmission is not performed in a symbol for transmitting uplink control information UCI on the PUCCH.

Qₘ indicates a modulation order corresponding to the PUCCH, and r indicates a code rate corresponding to the PUCCH.

In some implementations, in a case that a fifth condition is met, the second value includes the number of second parts of CSI reports transmitted on the PUCCH, and the total number of first parts of CSI reports that need to be multiplexed and transmitted on the PUCCH; and
the fifth condition is at least one of the following:

$${\sum }_{n = 1}^{{N}_{CSI - part 2}^{reported}} {O}_{CSI - part 2 , n} + {O}_{CRC , CSI - part 2 , N} \leq ( {M}_{RB}^{PUCCH} \cdot {N}_{sc , ctrl}^{RB} \cdot {N}_{symb - uci}^{PUCCH} - [ ( {O}_{ACK} + {O}_{SR} + {\sum }_{n = 1}^{{N}_{CSI}^{total}} {O}_{CSI - part 1 , n} + {O}_{CRC , CSI - part 1} ) / ( {Q}_{m} \cdot r ) ] ) \cdot {Q}_{m} \cdot r ; and$$

$${\sum }_{n = 1}^{{N}_{CSI - part 2}^{reported} + 1} {O}_{CSI - part 2 , n} + {O}_{CRC , CSI - part 2 , N + 1} > ( {M}_{RB}^{PUCCH} \cdot {N}_{sc , ctrl}^{RB} \cdot {N}_{symb - uci}^{PUCCH} - [ ( {O}_{ACK} + {O}_{SR} + {\sum }_{n = 1}^{{N}_{CSI}^{total}} {O}_{CSI - part 1 , n} + {O}_{CRC , CSI - part 1} ) / ( {Q}_{m} \cdot r ) ] ) \cdot {Q}_{m} \cdot r .$$

$${N}_{CSI - part 2}^{reported}$$

indicates the number of second parts of CSI reports transmitted on the PUCCH.

O_{ACK} indicates the number of bits of HARQ-ACK information transmitted on the PUCCH, and O_{SR} indicates the number of bits of SR information transmitted on the PUCCH.

O_{CRC,CSI-part2,N} indicates the number of CRC bits corresponding to

$${O}_{ACK} + {O}_{SR} + {\sum }_{n = 1}^{{N}_{CSI}^{reported}} {O}_{CSI - part 2 , n} ,$$

and O_{CSI-part2,n} indicates the number of bits of the second part of the n-th CSI report.

O_{CRC,CSI-part2,N+1} indicates the number of CRC bits corresponding to

$${O}_{ACK} + {O}_{SR} + {\sum }_{n = 1}^{{N}_{CSI}^{reported} + 1} {O}_{CSI - part 2 , n} ,$$

and O_{CSI-part2,n} indicates the number of bits of the second part of the n-th CSI report.

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

where O_{CSI-part1,n} indicates the number of bits of the first part of the n-th CSI report.

$${N}_{CSI}^{total}$$

indicates the total number of CSI reports that need to be multiplexed and transmitted on the PUCCH.

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB}$$

indicates the number of subcarriers available for transmitting UCI in a single PRB.

Qₘ indicates a modulation order corresponding to the PUCCH, and r indicates a code rate corresponding to the PUCCH.

In some implementations, in a case that the fifth condition is not met, the second value is equal to the number of first parts of CSI reports transmitted on the PUCCH and meeting a sixth condition; and

the sixth condition includes at least one of the following:

$$( {O}_{ACK} + {O}_{SR} + {\sum }_{n = 1}^{{N}_{CSI - part 1}^{reported}} {O}_{CSI - part 1 , n} + {O}_{CRC , CSI - part 1 , N} ) \leq {M}_{RB}^{PUCCH} \cdot {N}_{sc , ctrl}^{RB} \cdot {N}_{symb - UCI}^{PUCCH} \cdot {Q}_{m} \cdot r ; and$$

$$( {O}_{ACK} + {O}_{SR} + {\sum }_{n = 1}^{{N}_{CSI - part 1}^{reported} + 1} {O}_{CSI - part 1 , n} + {O}_{CRC , CSI - part 1 , N + 1} ) > {M}_{RB}^{PUCCH} \cdot {N}_{sc , ctrl}^{RB} \cdot {N}_{symb - UCI}^{PUCCH} \cdot {Q}_{m} \cdot r .$$

$${N}_{CSI - part 1}^{reported}$$

indicates the number of first parts of CSI reports transmitted on the PUCCH.

O_{ACK} indicates the number of bits of HARQ-ACK information transmitted on the PUCCH, and O_{SR} indicates the number of bits of SR information transmitted on the PUCCH.

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

where O_{CSI-part1,n} indicates the number of bits of the first part of the n-th CSI report.

O_{CRC,CSI-part1,N+1} indicates the number of CRC bits corresponding to

$${O}_{ACK} + {O}_{SR} + {\sum }_{n = 1}^{{N}_{CSI}^{reported} + 1} {O}_{CSI - part 1 , n} .$$

$${N}_{CSI}^{total}$$

indicates the total number of CSI reports that need to be multiplexed and transmitted on the PUCCH.

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB}$$

indicates the number of subcarriers available for transmitting UCI in a single PRB.

Qₘ indicates a modulation order corresponding to the PUCCH, and r indicates a code rate corresponding to the PUCCH.

In some implementations, the uplink muting pattern is applicable to at least one of the following:
a dynamically scheduled PUSCH;
a configured grant PUSCH; and
a PUCCH.

In some implementations, a CRC in a downlink control information DCI format of the dynamically scheduled PUSCH is scrambled by at least one of the following:
a cell-radio network temporary identifier C-RNTI;
a modulation and coding scheme cell-radio network temporary identifier MCS-C-RNTI; and
a configured scheduling radio network temporary identifier CS-RNTI.

In some implementations, a resource that is indicated by the uplink muting pattern and on which transmission is not performed does not overlap a symbol or an RE in which a DMRS of the uplink channel is located; or
a resource that is indicated by the uplink muting pattern and on which transmission is not performed does not overlap an RE in which a phase tracking reference signal PTRS of the PUSCH is located; or
the terminal does not expect a resource that is indicated by the uplink muting pattern and on which transmission is not performed to overlap a symbol or an RE in which a DMRS of the uplink channel is located; or
the terminal does not expect a resource that is indicated by the uplink muting pattern and on which transmission is not performed to overlap an RE in which a phase tracking reference signal PTRS of the PUSCH is located.

In some implementations, the configuration information is higher-layer signaling configuration information; or
in a case that the terminal obtains an uplink muting pattern configured by using layer 1 or layer 2 signaling, the terminal does not use the uplink muting pattern configured by using layer 1 or layer 2 signaling during calculation of a TBS of the uplink channel.

In some implementations, the number of first REs is determined based on the uplink muting pattern, or the number of first REs is configured by a higher layer.

In some implementations, in a case that the UCI is multiplexed and transmitted on the PUSCH, the resources that are indicated by the uplink muting pattern and on which transmission is not performed are skipped for UCI mapping.

In some implementations, in a case that the effective channel code rate of the uplink channel is greater than a preset threshold, the terminal does not transmit the uplink channel; or the terminal does not expect the effective channel code rate of the uplink channel to be greater than the preset threshold.

The communication apparatus can improve the transmission performance of the terminal.

The transmission information determining apparatus in this embodiment of this application may be an electronic device, such as an electronic device with an operating system, or a component in the electronic device, such as an integrated circuit or a chip. The electronic device may be a terminal or a device other than terminals. For example, the terminal may include, but is not limited to, the types of the terminal 11 listed above, and other devices may be a server, a Network Attached Storage (NAS), and the like. This is not limited in the embodiments of this application.

The transmission information determining apparatus provided in this embodiment of this application can implement the processes implemented in the method embodiment in FIG. 2, with the same technical effects achieved. To avoid repetition, details are not described herein again.

The execution subject of the configuration information sending method provided in the embodiments of this application may be a configuration information sending apparatus. In the embodiments of this application, the configuration information sending apparatus provided in the embodiments of this application is described by using the configuration information sending method being executed by the configuration information sending apparatus as an example.

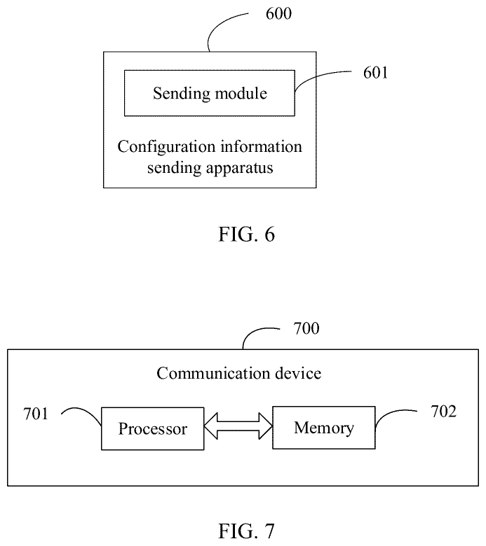

Referring to FIG. 6, FIG. 6 is a schematic structural diagram of a configuration information sending apparatus according to an embodiment of this application. As shown in FIG. 6, the configuration information sending apparatus 600 includes:
a sending module 601, configured to send configuration information to a terminal, where the configuration information is used for configuring an uplink muting pattern, and the uplink muting pattern is used for indicating resources on which transmission is not performed.

In some implementations, the uplink muting pattern is applicable to at least one of the following:
a dynamically scheduled PUSCH;
a configured grant PUSCH; and
a PUCCH.

In some implementations, a CRC in a downlink control information DCI format of the dynamically scheduled PUSCH is scrambled by at least one of the following:
a cell-radio network temporary identifier C-RNTI;
a modulation and coding scheme cell-radio network temporary identifier MCS-C-RNTI; and
a configured scheduling radio network temporary identifier CS-RNTI.

In some implementations, a resource that is indicated by the uplink muting pattern and on which transmission is not performed does not overlap a symbol or an RE in which a DMRS of the uplink channel is located; or
a resource that is indicated by the uplink muting pattern and on which transmission is not performed does not overlap an RE in which a phase tracking reference signal PTRS of a PUSCH is located.

In some implementations, the configuration information is higher-layer signaling configuration information.

The communication apparatus can improve the transmission performance of the terminal.

The configuration information sending apparatus in this embodiment of this application may be an electronic device, such as an electronic device with an operating system, or a component in the electronic device, such as an integrated circuit or a chip. The electronic device may be a terminal or a network-side device.

The configuration information sending apparatus provided in this embodiment of this application is capable of implementing the processes implemented in the method embodiments in FIG. 4, with the same technical effects achieved. To avoid repetition, details are not described herein again.

As shown in FIG. 7, an embodiment of this application further provides a communication device 700, including a processor 701 and a memory 702. A program or instructions capable of running on the processor 701 are stored in the memory 702. For example, when the communication device 700 is a terminal and when the program or the instructions are executed by the processor 701, the steps of the foregoing embodiments of the transmission information determining method are implemented, with the same technical effects achieved. When the communication device 700 is a network-side device and when the program or instructions are executed by the processor 701, the steps of the foregoing embodiments of the configuration information sending method are implemented, with the same technical effects achieved. To avoid repetition, details are not described herein again.

An embodiment of this application further provides a terminal, including a processor and a communication interface, where the communication interface is configured to obtain configuration information, where the configuration information is used for configuring an uplink muting pattern, and the uplink muting pattern is used for indicating resources on which transmission is not performed; and the processor is configured to determine transmission information of an uplink channel based on the number of first resource elements REs, where the number of first REs is the number of REs that are associated with the uplink muting pattern and on which transmission is not performed, and the uplink channel includes at least one of the following: a PUSCH and a PUCCH.

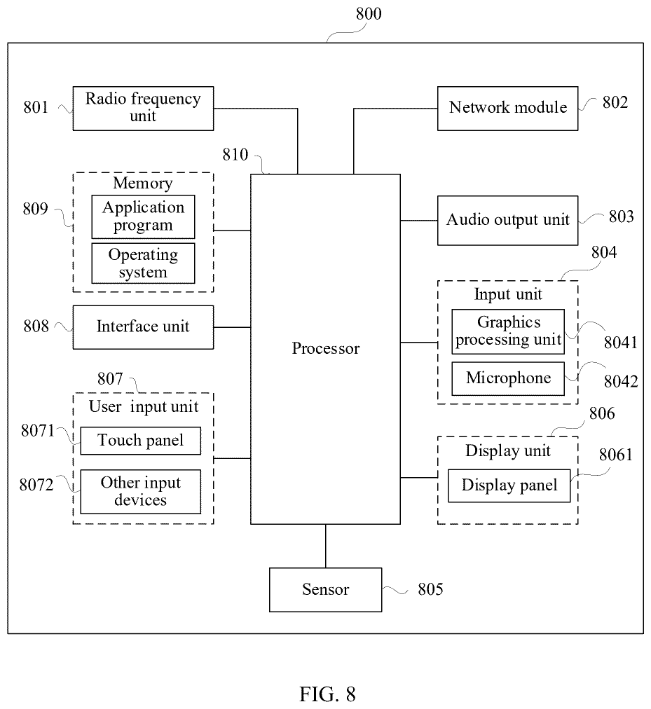

An embodiment of this application further provides a terminal, which includes a processor and a communication interface, where the communication interface is coupled to the processor, and the processor is configured to run a program or instructions to implement the steps of the method embodiments shown in FIG. 2. The terminal embodiment corresponds to the foregoing terminal side method embodiment, and the implementation processes and implementations of the foregoing method embodiments can be applied to the terminal embodiments, with the same technical effects achieved. Specifically, FIG. 8 is a schematic diagram of a hardware structure of a terminal implementing an embodiment of this application.

The terminal 800 includes but is not limited to at least part of components such as a radio frequency unit 801, a network module 802, an audio output unit 803, an input unit 804, a sensor 805, a display unit 806, a user input unit 807, an interface unit 808, a memory 809, and a processor 810.

Persons skilled in the art can understand that the terminal 800 may further include a power supply (for example, a battery) supplying power to the components, and the power supply may be logically connected to the processor 810 through a power management system. In this way, functions such as charge management, discharge management, and power consumption management are implemented by using the power management system. The structure of the terminal shown in FIG. 8 does not constitute any limitation on the terminal. The terminal may include more or fewer components than shown in the figure, or a combination of some components, or the components disposed differently. Details are not described herein again.

It can be understood that in this embodiment of this application, the input unit 804 may include a Graphics Processing Unit (GPU) 8041 and a microphone 8042. The graphics processing unit 8041 processes image data of a still picture or video obtained by an image capture apparatus (such as a camera) in a video capture mode or an image capture mode. The display unit 806 may include a display panel 8061. The display panel 8061 may be configured in a form of a liquid crystal display, an organic light-emitting diode display, or the like. The user input unit 807 includes at least one of a touch panel 8071 and other input devices 8072. The touch panel 8071 is also referred to as a touchscreen. The touch panel 8071 may include two parts: a touch detection apparatus and a touch controller. The other input devices 8072 may include but be not limited to a physical keyboard, a function key (such as a volume control key or an on/off key), a trackball, a mouse, and a joystick. Details are not described herein.

In this embodiment of this application, after receiving downlink data from a network-side device, the radio frequency unit 801 sends the downlink data to the processor 810 for processing; and the radio frequency unit 801 also sends uplink data to the network-side device. Generally, the radio frequency unit 801 includes but is not limited to an antenna, an amplifier, a transceiver, a coupler, a low noise amplifier, a duplexer, and the like.

The memory 809 may be configured to store software programs or instructions and various data. The memory 809 may mainly include a first storage area for storing programs or instructions and a second storage area for storing data, where the first storage area may store an operating system, an application program or instructions required by at least one function (for example, an audio playing function and an image playing function), and the like. Further, the memory 809 may include a volatile memory or a nonvolatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 809 described in the embodiments of this application is intended to include but is not limited to these and any other suitable types of memories.

The processor 810 may include one or more processing units. In some implementations, the processor 810 integrates an application processor and a modem processor. The application processor mainly processes operations related to an operating system, a user interface, an application program, and the like. The modem processor mainly processes wireless communication signals, for example, a baseband processor. It can be understood that the modem processor may be not integrated in the processor 810.

The radio frequency unit 801 is configured to obtain configuration information, where the configuration information is used for configuring an uplink muting pattern, and the uplink muting pattern is used for indicating resources on which transmission is not performed.

The processor 810 is configured to determine transmission information of an uplink channel based on the number of first resource elements REs, where the number of first REs is the number of REs that are associated with the uplink muting pattern and on which transmission is not performed, and the uplink channel includes at least one of the following:
a physical uplink shared channel PUSCH and a physical uplink control channel PUCCH.

In some implementations, the transmission information includes at least one of the following:
a transport block size TBS;
a transmission resource;
the number of physical resource blocks PRBs for transmission;
the number of channel state information CSI reports for transmission; and
an effective channel code rate.

In some implementations, the determining transmission information of an uplink channel based on the number of first REs includes:
calculating, based on the number of first REs, the number of second REs allocated to the PUSCH in a single PRB, where the number of first REs is the number of REs that are associated with the uplink muting pattern and on which transmission is not performed in a single PRB; and
calculating a TBS of the PUSCH based on the number of second REs.

In some implementations, the number of second REs is a value obtained by subtracting a first value from a first product, where
the first product is a product of the number of subcarriers contained in a single PRB and the number of symbols of the PUSCH scheduled in a single slot; and
the first value is a sum of the following three values:
a configured overhead in a serving cell configuration corresponding to the PUSCH, the number of first REs, and the number of REs occupied by a demodulation reference signal DMRS in a single PRB within an allocation period of the PUSCH.

In some implementations, the determining transmission information of an uplink channel based on the number of first REs includes:
calculating the number of third REs allocated to the PUSCH in a single PRB;
calculating the total number of REs allocated to the PUSCH in a single slot based on the number of first REs, the number of third REs, and the number of PRBs allocated to the terminal, where the number of first REs is the number of REs that are associated with the uplink muting pattern and on which transmission is not performed in a PRB for transmitting the PUSCH; and
calculating a TBS of the PUSCH based on the total number of REs.

In some implementations, the total number of REs is a value obtained by subtracting the number of first REs from a second product, where
the second product is a product of a minimum value and the number of PRBs allocated to the terminal, and the minimum value is a minimum value in the number of third REs and a preset threshold.

In some implementations, the number of PRBs for transmission includes: a minimum number of PRBs for transmission of the PUCCH, where
a value of the minimum number of PRBs for transmission of the PUCCH is a minimum value of the number of PRBs for transmission of the PUCCH in a case that the number of PRBs for transmission of the PUCCH meets a first condition; and
the first condition is a condition including the number of first REs.

In some implementations, the first condition includes:

$$( {O}_{UCI} + {O}_{CRC} ) \leq ( {M}_{RB , min}^{PUCCH} \cdot {N}_{sc , ctrl}^{RB} \cdot {N}_{symb - UCI}^{PUCCH} - M {1}_{RE}^{rate - matchig} ) \cdot {Q}_{m} \cdot r , and ( {O}_{UCI} + {O}_{CRC} ) > [ ( {M}_{RB , min}^{PUCCH} - 1 ) \cdot {N}_{sc , ctrl}^{RB} \cdot {N}_{symb - UCI}^{PUCCH} - M {2}_{RE}^{rate - matchig} ] \cdot {Q}_{m} \cdot r ; or$$

$$( {O}_{UCI} + {O}_{CRC} ) \leq ( {M}_{RB , min}^{PUCCH} \cdot ( {N}_{sc , ctrl}^{RB} \cdot {N}_{symb - UCI}^{PUCCH} - M {3}_{RE}^{rate - matchig} ) ) \cdot {Q}_{m} \cdot r , and ( {O}_{UCI} + {O}_{CRC} ) > [ ( {M}_{RB , min}^{PUCCH} - 1 ) \cdot ( {N}_{sc , ctrl}^{RB} \cdot {N}_{symb - UCI}^{PUCCH} - M {3}_{RE}^{rate - matchig} ) ] \cdot {Q}_{m} \cdot r .$$

$$M {1}_{RE}^{rate - matchig}$$

indicates the first value of the number of first REs, and the first value is the number of REs that are associated with the uplink muting pattern and on which transmission is not performed in,

$${M}_{RB , min}^{PUCCH}$$

PRBs for the transmission of the PUCCH within a symbol for transmitting UCI on the PUCCH.

$$M {2}_{RE}^{rate - matchig}$$

indicates a second value of the number of first REs, and the second value is the number of REs that are associated with the uplink muting pattern and on which transmission is not performed in

$${M}_{RB , min}^{PUCCH} - 1 PRBs$$

for transmission of the PUCCH within a symbol for transmitting UCI on the PUCCH.

$$M {3}_{RE}^{rate - matchig}$$

indicates a third value of the number of first REs, and the third value is the number of REs that are associated with the uplink muting pattern and on which transmission is not performed in a single PRB within a symbol for transmitting UCI on the PUCCH.

O_{CRC} indicates the number of bits of cyclic redundancy check CRC information for transmission of the PUCCH, and O_{UCI} indicates the number of bits of UCI transmitted on the PUCCH.

$${M}_{RB , min}^{PUCCH}$$

indicates a minimum number of PRBs for transmission of the PUCCH.

$${N}_{symb - UCI}^{PUCCH}$$

indicates the number of symbols available for transmitting UCI on the PUCCH, and

$${N}_{sc , ctrl}^{RB}$$

indicates the number of subcarriers available for transmitting UCI in a single PRB.

Qₘ indicates a modulation order corresponding to the PUCCH, and r indicates a code rate corresponding to the PUCCH.

In some implementations, the number of CSI reports for transmission includes the number of CSI reports transmitted on the PUCCH, where:
in a case that a second condition is met, the number of CSI reports transmitted on the PUCCH is the total number of CSI reports that need to be multiplexed and transmitted on the PUCCH; or
in a case that the second condition is not met, the number of CSI reports transmitted on the PUCCH is a second value, and the CSI reports transmitted on the PUCCH are a second-value number of CSI reports selected in ascending order of priority values in CSI reports to be multiplexed and transmitted on the PUCCH, where the second value is a maximum number of CSI reports determined in a case that a transmission code rate is not greater than a configured code rate; where
the second condition is a condition including the number of first REs.

In some implementations, the second condition includes:

$$( {O}_{UCI} + {O}_{CRC} ) \leq ( {M}_{PRB}^{PUCCH} \cdot {N}_{sc , ctrl}^{RB} \cdot {N}_{symb - uci}^{PUCCH} - M {4}_{RE}^{rate - matchig} ) \cdot {Q}_{m} \cdot r ; or$$

$$( {O}_{UCI} + {O}_{CRC} ) \leq ( {M}_{PRB}^{PUCCH} \cdot ( {N}_{sc , ctrl}^{RB} \cdot {N}_{symb - uci}^{PUCCH} - M {5}_{RE}^{rate - matchig} ) ) \cdot {Q}_{m} \cdot r .$$

$$M {4}_{RE}^{rate - matchig}$$

indicates a fourth value of the number of first REs, where the fourth value is the number of REs that are associated with the uplink muting pattern and on which transmission is not performed in

$${M}_{PRB}^{PUCCH}$$

PRBs within a symbol for transmitting UCI on the PUCCH.

$$M {5}_{RE}^{rate - matchig}$$

Indicates a mini value of the number of first REs, where the fifth value is the number of REs that are associated with the uplink muting pattern and on which transmission is not performed in a single PRB within a symbol for transmitting UCI on the PUCCH.

O_{CRC} indicates the number of bits of cyclic redundancy check CRC information for transmission of the PUCCH, and O_{UCI} indicates the number of bits of UCI transmitted on the PUCCH.

$${M}_{PRB}^{PUCCH}$$

indicates the number or PRBs configured for the PUCCH.

$${N}_{symb - UCI}^{PUCCH}$$

indicates the number of symbols available for transmitting UCI on the PUCCH, and

$${N}_{sc , ctrl}^{RB}$$

indicates the number or subcarriers available for transmitting UCI in a single PRB.

Qₘ indicates a modulation order corresponding to the PUCCH, and r indicates a code rate corresponding to the PUCCH.

In some implementations, the transmission resource includes a transmission resource of the PUCCH, where:
the transmission resource of the PUCCH includes a resource selected on J PUCCH resources in at least one of the following manners:
in a case that a third condition is met, selecting a PUCCH resource with an index of 0 from the J PUCCH resources, where the third condition is a condition including the number of first REs, and J is a positive integer:
in a case that the third condition is not met and the fourth condition is met, selecting a PUCCH resource with an index of j+1 from the J PUCCH resources, where the fourth condition is a condition including the number of first REs, and 0≤j<J−1; and
in a case that the third condition is not met and the fourth condition is not met, selecting a PUCCH resource with an index of J−1 from the J PUCCH resources; where
the J PUCCH resources are PUCCH resources used for transmitting multiple CSIs, and resource indexes of the J PUCCH resources are numbered in ascending order of products of the corresponding number of REs, a modulation order and a configured code rate.

In some implementations, the third condition includes:

$$( {O}_{UCI} + {O}_{CRC} ) \leq {[ ( {M}_{PRB}^{PUCCH} \cdot {N}_{sc , ctrl}^{RB} \cdot {N}_{symb - uci}^{PUCCH} - M {6}_{RE}^{rate - matchig} ) \cdot {Q}_{m} \cdot r ]}_{0} ;$$

$$or$$

$$( {O}_{UCI} + {O}_{CRC} ) \leq {[ ( {M}_{PRB}^{PUCCH} \cdot ( {N}_{sc , ctrl}^{RB} \cdot {N}_{symb - uci}^{PUCCH} - M {7}_{RE}^{rate - matchig} ) ) \cdot {Q}_{m} \cdot r ]}_{0} .$$

The fourth condition includes:

$$( {O}_{UCI} + {O}_{CRC} ) > {[ ( {M}_{PRB}^{PUCCH} \cdot {N}_{sc , ctrl}^{RB} \cdot {N}_{symb - uci}^{PUCCH} - M {6}_{RE}^{rate - matchig} ) \cdot {Q}_{m} \cdot r ]}_{j} ,$$

$$and$$

$$( {O}_{UCI} + {O}_{CRC} ) \leq {[ ( {M}_{PRB}^{PUCCH} \cdot {N}_{sc , ctrl}^{RB} \cdot {N}_{symb - uci}^{PUCCH} - M {6}_{RE}^{rate - matchig} ) \cdot {Q}_{m} \cdot r ]}_{j + 1} , 0 \leq j < J - 1 ;$$

$$or$$

$$( {O}_{UCI} + {O}_{CRC} ) > {[ ( {M}_{PRB}^{PUCCH} \cdot ( {N}_{sc , ctrl}^{RB} \cdot {N}_{symb - uci}^{PUCCH} - M {7}_{RE}^{rate - matchig} ) ) \cdot {Q}_{m} \cdot r ]}_{j} ,$$

$$and$$

$$( {O}_{UCI} + {O}_{CRC} ) \leq {[ ( {M}_{PRB}^{PUCCH} \cdot ( {N}_{sc , ctrl}^{RB} \cdot {N}_{symb - uci}^{PUCCH} - M {7}_{RE}^{r a t e - m a t c h i g} ) ) \cdot {Q}_{m} \cdot r ]}_{j + 1} , 0 \leq j < J - 1.$$

$$M {6}_{RE}^{rate - matchig}$$

indicates a sixth value of the number of first REs, and the sixth value is the number of REs that are associated with the uplink muting pattern and on which transmission is not performed within a symbol for transmitting UCI on the PUCCH.

$$M {7}_{RE}^{rate - matchig}$$

indicates a seventh value of the number of first REs, and the seventh value is the number of REs that are associated with the uplink muting pattern and on which transmission is not performed in a single PRB within a symbol for transmitting UCI on the PUCCH.

O_{CRC} indicates the number of bits of cyclic redundancy check CRC information for transmission of the PUCCH, and O_{UCI} indicates the number of bits of UCI transmitted on the PUCCH.

$${M}_{PRB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB }$$

indicates the number of subcarriers available for transmitting UCI in a single PRB.

Qₘ indicates a modulation order corresponding to the PUCCH, and r indicates a code rate corresponding to the PUCCH.

[ ]₀ indicates calculating an operation within [ ] by using information of the PUCCH resource with the index of 0, [ ]ⱼ indicates calculating an operation within [ ] by using information of the PUCCH resource with the index of j, and [ ]ⱼ₊₁ indicates calculating an operation within [ ] by using information of the PUCCH resource with the index of j+1.

In some implementations, the number of CSI reports for transmission includes the number of CSI reports transmitted on the PUCCH, where
in a case that the third condition is met, the number of CSI reports transmitted on the PUCCH is the total number of CSI reports that need to be multiplexed and transmitted on the PUCCH; or
in a case that the third condition is not met and the fourth condition is met, the number of CSI reports transmitted on the PUCCH is the total number of CSI reports that need to be multiplexed and transmitted on the PUCCH; or
in a case that the third condition is not met and the fourth condition is not met, the number of CSI reports transmitted on the PUCCH is a second value, and the CSI reports transmitted on the PUCCH are a second-value number of CSI reports selected in ascending order of priority values in CSI reports to be multiplexed and transmitted on the PUCCH, where the second value is a maximum number of CSI reports determined in a case that a transmission code rate is not greater than a configured code rate.

In some implementations, the second value satisfies at least one of the following conditions:

$$( {O}_{ACK} + {O}_{SR} + {\sum }_{n = 1}^{{N}_{CSI}^{reported}} {O}_{CSI - part 1 , n} + {O}_{CRC , CSI - part 1 , N} ) \leq ( {M}_{PRB}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r ;$$

$$( {O}_{ACK} + {O}_{S R} + {\sum }_{n = 1}^{{N}_{CSI}^{reported}} {O}_{CSI - part 1 , n} + {O}_{CRC , CSI - part 1 , N} ) \leq {M}_{RB}^{PUCCH} \cdot {N}_{sc , ctrl}^{RB} \cdot {N}_{s ymb - UCI}^{PUCCH} \cdot {Q}_{m} \cdot r ;$$

$$and$$

$$( {O}_{ACK} + {O}_{SR} + {\sum }_{n = 1}^{{N}_{CSI}^{{reported}_{+ 1}}} {O}_{CSI - part 1 , n} + {O}_{CRC , CSI - part 1 , N} ) > ( {M}_{PRB}^{PUCCH} \cdot {N}_{sc , ctrl}^{RB} \cdot {N}_{symb - uci}^{PUCCH} - {M}_{RE}^{rate - matchig} ) \cdot {Q}_{m} \cdot r .$$

$${N}_{CSI}^{reported}$$

indicates the second value, O_{ACK} indicates the number of bits of HARQ-ACK information transmitted on the PUCCH, and O_{SR} indicates the number of bits of SR information transmitted on the PUCCH.

O_{CRC,CSI-part1,N} indicates the number of CRC bits corresponding to

$${O}_{ACK} + {O}_{SR} + {\sum }_{n = 1}^{{N}_{CSI}^{reported}} {O}_{CSI - part 1 , n} ,$$

where O_{CSI-part1,n} indicates the number of bits of the first part of the n-th CSI report.

$${M}_{PRB}^{PUCCH}$$

indicates the number of PRBs configured for the PUCCH, and

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB}$$

indicates the number or subcarriers available for transmitting UCI in a single PRB.

$${M}_{RE}^{rate - matchig}$$

indicates the number of REs, and the number of first REs is the number of REs that are associated with the uplink muting pattern and on which transmission is not performed in a symbol for transmitting uplink control information UCI on the PUCCH.

Qₘ indicates a modulation order corresponding to the PUCCH, and r indicates a code rate corresponding to the PUCCH.

In some implementations, in a case that a fifth condition is met, the second value includes the number of second parts of CSI reports transmitted on the PUCCH, and the total number of first parts of CSI reports that need to be multiplexed and transmitted on the PUCCH; and
the fifth condition is at least one of the following:

$${\sum }_{n = 1}^{{N}_{CSI - part 2}^{reported}} {O}_{CSI - part 2 , n} + {O}_{CRC , CSI - part 2 , N} \leq ( {M}_{RB}^{PUCCH} \cdot {N}_{sc , ctrl}^{RB} \cdot {N}_{symb - uci}^{PUCCH} - [ ( {O}_{ACK} + {O}_{SR} + {\sum }_{n = 1}^{{N}_{CSI}^{total}} {O}_{CSI - part 1 , n} + {O}_{CRC , CSI - part 1} ) / ( {Q}_{m} \cdot r ) ] ) \cdot {Q}_{m} \cdot r ;$$

$$and$$

$${\sum }_{n = 1}^{{N}_{CSI - part 2}^{reported} + 1} {O}_{CSI - part 2 , n} + {O}_{CRC , CSI - part 2 , N + 1} > ( {M}_{RB}^{PUCCH} \cdot {N}_{sc , ctrl}^{RB} \cdot {N}_{symb - uci}^{PUCCH} - [ ( {O}_{ACK} + {O}_{SR} + {\sum }_{n = 1}^{{N}_{CSI}^{total}} {O}_{CSI - part 1 , n} + {O}_{CRC , CSI - part 1} ) / ( {Q}_{m} \cdot r ) ] ) \cdot {Q}_{m} \cdot r .$$

$${N}_{CSI - part 2}^{reported}$$

indicates the number or second parts of CSI reports transmitted on the PUCCH.

O_{ACK} indicates the number of bits of HARQ-ACK information transmitted on the PUCCH, and O_{SR} indicates the number of bits of SR information transmitted on the PUCCH.

O_{CRC,CSI-part2,N} indicates the number of CRC bits corresponding to

$${O}_{ACK} + {O}_{S R} + {\sum }_{n = 1}^{{N}_{CSI}^{reported}} {O}_{CSI - part 2 , n} ,$$

and O_{CSI-part2,n} indicates the number of bits of the second part of the n-th CSI report.

O_{CRC,CSI-part2,N+1} indicates the number of CRC bits corresponding to

$${O}_{ACK} + {O}_{S R} + {\sum }_{n = 1}^{{N}_{CSI}^{reported} + 1} {O}_{CSI - part 2 , n} ,$$

and O_{CSI-part2,n} indicates the number of bits of the second part of the n-th CSI report.

O_{CRC,CSI-part1,N} indicates the number of CRC bits corresponding to

$${O}_{ACK} + {O}_{S R} + {\sum }_{n = 1}^{{N}_{CSI}^{reported}} {O}_{CSI - part 1 , n} ,$$

where O_{CSI-part1,n} indicates the number of bits of the first part of the n-th CSI report.

$${N}_{CSI}^{total}$$

indicates the total number of CSI reports that need to be multiplexed and transmitted on the PUCCH.

$${M}_{RB}^{PUCCH}$$

indicates the number of PRBs configured for the PUCCH.

$${N}_{symb - UCI}^{PUCCH}$$

indicates the number of symbols available for transmitting UCI on the PUCCH, and

$${N}_{sc , ctrl}^{RB}$$

indicates the number or subcarriers available for transmitting UCI in a single PRB.

Qₘ indicates a modulation order corresponding to the PUCCH, and r indicates a code rate corresponding to the PUCCH.

In some implementations, in a case that the fifth condition is not met, the second value is equal to the number of first parts of CSI reports transmitted on the PUCCH and meeting a sixth condition; and
the sixth condition includes at least one of the following:

$$( {O}_{ACK} + {O}_{SR} + {{\sum }_{n = 1}}^{{N}_{CSI - part 1}^{reported}} {O}_{CSI - part 1 , n} + {O}_{CRC , CSI - part 1 , N} ) \leq {M}_{RB}^{PUCCH} \cdot {N}_{sc , ctrl}^{RB} \cdot {N}_{symb - UCI}^{PUCCH} \cdot {Q}_{m} \cdot r ;$$

$$and$$

$$( {O}_{ACK} + {O}_{S R} + {{\sum }_{n = 1}}^{{N}_{CSI - part 1}^{reported} + 1} {O}_{CSI - part 1 , n} + {O}_{CRC , CSI - part 1 , N + 1} ) > {M}_{RB}^{PUCCH} \cdot {N}_{sc , ctrl}^{RB} \cdot {N}_{symb - UCI}^{PUCCH} \cdot {Q}_{m} \cdot r .$$

$${N}_{CSI - part 1}^{reported}$$

indicates the number of first parts of CSI reports transmitted on the PUCCH.

O_{ACK} indicates the number of bits of HARQ-ACK information transmitted on the PUCCH, and O_{SR} indicates the number of bits of SR information transmitted on the PUCCH.

O_{CRC,CSI-part1,N} indicates the number of CRC bits corresponding to

$${O}_{ACK} + {O}_{S R} + {\sum }_{n = 1}^{{N}_{CSI}^{reported}} {O}_{CSI - part 1 , n} ,$$

where O_{CSI-part1,n} indicates the number of bits of the first part of the n-th CSI report.

O_{CRC,CSI-part1,N+1} indicates the number of CRC bits corresponding to

$${O}_{ACK} + {O}_{S R} + {\sum }_{n = 1}^{{N}_{CSI}^{reported} + 1} {O}_{CSI - part 1 , n} .$$

$${N}_{CSI}^{total}$$

indicates the total number of CSI reports that need to be multiplexed and transmitted on the PUCCH.

$${M}_{RB}^{PUCCH}$$

indicates the number or PRBs configured for the PUCCH.

$${N}_{symb - UCI}^{PUCCH}$$

indicates the number of symbols available for transmitting UCI on the PUCCH, and

$${N}_{sc , ctrl}^{RB}$$

indicates the number or subcarriers available for transmitting UCI in a single PRB.

Qₘ indicates a modulation order corresponding to the PUCCH, and r indicates a code rate corresponding to the PUCCH.

In some implementations, the uplink muting pattern is applicable to at least one of the following:
a dynamically scheduled PUSCH;
a configured grant PUSCH; and
a PUCCH.

In some implementations, a CRC in a downlink control information DCI format of the dynamically scheduled PUSCH is scrambled by at least one of the following:
a C-RNTI;
an MCS-C-RNTI; and
a CS-RNTI.

In some implementations, a resource that is indicated by the uplink muting pattern and on which transmission is not performed does not overlap a symbol or an RE in which a DMRS of the uplink channel is located; or
a resource that is indicated by the uplink muting pattern and on which transmission is not performed does not overlap an RE in which a phase tracking reference signal PTRS of the PUSCH is located; or
the terminal does not expect a resource that is indicated by the uplink muting pattern and on which transmission is not performed to overlap a symbol or an RE in which a DMRS of the uplink channel is located; or
the terminal does not expect a resource that is indicated by the uplink muting pattern and on which transmission is not performed to overlap an RE in which a phase tracking reference signal PTRS of the PUSCH is located.

In some implementations, the configuration information is higher-layer signaling configuration information; or
in a case that the terminal obtains an uplink muting pattern configured by using layer 1 or layer 2 signaling, the terminal does not use the uplink muting pattern configured by using layer 1 or layer 2 signaling during calculation of a TBS of the uplink channel.

In some implementations, the number of first REs is determined based on the uplink muting pattern, or the number of first REs is configured by a higher layer.

In some implementations, in a case that the UCI is multiplexed and transmitted on the PUSCH, the resources that are indicated by the uplink muting pattern and on which transmission is not performed are skipped for UCI mapping.

In some implementations, in a case that the effective channel code rate of the uplink channel is greater than a preset threshold, the terminal does not transmit the uplink channel; or the terminal does not expect the effective channel code rate of the uplink channel to be greater than the preset threshold.

The terminal can improve the transmission performance of the terminal.

It can be understood that for the implementation processes of the implementations mentioned in this embodiment, reference may be made to the related descriptions of the method embodiments, with the same or corresponding technical effects achieved. To avoid repetition, details are not described herein again.

An embodiment of this application further provides a network-side device, including a processor and a communication interface, where the communication interface is configured to send configuration information to a terminal, where the configuration information is used for configuring an uplink muting pattern, and the uplink muting pattern is used for indicating resources on which transmission is not performed.

An embodiment of this application further provides a network-side device, which includes a processor and a communication interface, where the communication interface is coupled to the processor, and the processor is configured to run a program or instructions to implement the steps of the method embodiments shown in FIG. 4. The radio access network device embodiment corresponds to the foregoing network-side device method embodiment, and the implementation processes and implementations of the foregoing method embodiments can be applied to the network-side device embodiment, with the same technical effects achieved.

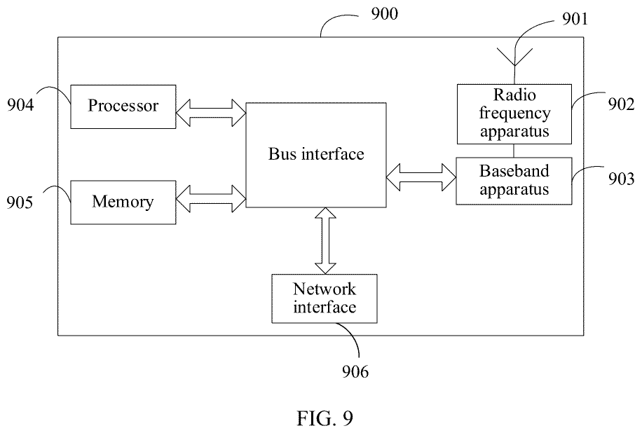

An embodiment of this application further provides a network-side device. As shown in FIG. 9, the network-side device 900 includes an antenna 901, a radio frequency apparatus 902, a baseband apparatus 903, a processor 904, and memory 905. The antenna 901 is connected to the radio frequency apparatus 902. In an uplink direction, the radio frequency apparatus 902 receives information by using the antenna 901, and sends the received information to the baseband apparatus 903 for processing. In a downlink direction, the baseband apparatus 903 processes to-be-sent information, and sends the information to the radio frequency apparatus 902; and the radio frequency apparatus 902 processes the received information and then sends the information out by using the antenna 901.

The method executed by the network-side device in the foregoing embodiments may be implemented on the baseband apparatus 903. The baseband apparatus 903 includes a baseband processor.

The baseband apparatus 903 may include, for example, at least one baseband board, where a plurality of chips are disposed on the baseband board. As shown in FIG. 9, one of the chips is, for example, the baseband processor, and connected to the memory 905 through a bus interface, to invoke the program in the memory 905 to perform the operations of the network device shown in the foregoing method embodiment.

The network-side device may further include a network interface 906, where the interface is, for example, a Common Public Radio Interface (CPRI).

In some implementations, the network-side device 900 according to this embodiment of this application further includes instructions or programs stored in the memory 905 and capable of running on the processor 904, and the processor 904 calls the instructions or programs in the memory 905 to execute the methods performed by the modules shown in FIG. 6, with the same technical effects achieved. To avoid repetition, details are not described herein again.

The radio frequency apparatus 902 is configured to send configuration information to a terminal, where the configuration information is used for configuring an uplink muting pattern, and the uplink muting pattern is used for indicating resources on which transmission is not performed.

In some implementations, the uplink muting pattern is applicable to at least one of the following:
a dynamically scheduled PUSCH;
a configured grant PUSCH; and
a PUCCH.

In some implementations, a CRC in a downlink control information DCI format of the dynamically scheduled PUSCH is scrambled by at least one of the following:
a cell-radio network temporary identifier C-RNTI;
a modulation and coding scheme cell-radio network temporary identifier MCS-C-RNTI; and
a configured scheduling radio network temporary identifier CS-RNTI.

In some implementations, a resource that is indicated by the uplink muting pattern and on which transmission is not performed does not overlap a symbol or an RE in which a DMRS of the uplink channel is located; or
a resource that is indicated by the uplink muting pattern and on which transmission is not performed does not overlap an RE in which a phase tracking reference signal PTRS of a PUSCH is located.

In some implementations, the configuration information is higher-layer signaling configuration information.

The network-side device can improve the transmission performance of the terminal.

An embodiment of this application further provides a readable storage medium, where the readable storage medium stores a program or instructions, and when the program or instructions are executed by a processor, the processes of the foregoing embodiments of the transmission information determining method or the configuration information sending method are implemented, with the same technical effects achieved. To avoid repetition, details are not described herein again.

The processor is a processor in the terminal described in the foregoing embodiment. The readable storage medium includes a computer-readable storage medium such as a computer ROM, a RAM, a magnetic disk, or an optical disc. In some examples, the readable storage medium may be a non-transitory readable storage medium.

An embodiment of this application further provides a chip, where the chip includes a processor and a communication interface. The communication interface is coupled to the processor, and the processor is configured to run a program or instructions to implement the processes of the foregoing embodiments of the transmission information determining method or the configuration information sending method, with the same technical effects achieved. To avoid repetition, details are not described herein again.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and when being executed by at least one processor, the computer program/program product is configured to implement the processes of the foregoing embodiments of the transmission information determining method or the configuration information sending method, with the same technical effects achieved. To avoid repetition, details are not repeated herein.

An embodiment of this application further provides a wireless communication system, including a terminal and a network-side device, where the terminal can be configured to execute the steps of the transmission information determining method provided in the embodiments of this application, and the network-side device can be configured to execute the steps of the configuration information sending method provided in the embodiments of this application.

It should be noted that in this specification, the terms “include” and “comprise,” or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples can be combined in other examples.

According to the description of the foregoing implementations, persons skilled in the art can clearly understand that the method in the foregoing embodiments may be implemented by a computer software product in combination with a necessary general hardware platform. Specifically, the method in the foregoing embodiments may be implemented by hardware. The computer software product is stored in a storage medium (such as a ROM, a RAM, a magnetic disk, or an optical disc), and includes several instructions to enable a terminal or a network-side device to execute the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other implementation manners without departing from principles of this application and the protection scope of the claims, many and all such implementation manners fall within the protection scope of this application.

What is claimed is:

1. A transmission information determining method, performed by a terminal, comprising:
obtaining configuration information, wherein the configuration information is used for configuring an uplink muting pattern, and the uplink muting pattern is used for indicating resources on which transmission is not performed; and
determining transmission information of an uplink channel based on a number of first Resource Elements (REs),
wherein the number of the first REs is the number of REs that are associated with the uplink muting pattern and on which transmission is not performed, and the uplink channel comprises:
a Physical Uplink Shared CHannel (PUSCH).

2. The method according to claim 1, wherein the transmission information comprises at least one of the following:
a transmission resource; or
a number of Channel State Information (CSI) reports for transmission.

3. The method according to claim 1, wherein the uplink muting pattern is applicable to at least one of the following:
a dynamically scheduled PUSCH; or
a configured grant PUSCH.

4. The method according to claim 3, wherein a Cyclic Redundancy Check (CRC) in a Downlink Control Information (DCI) format of the dynamically scheduled PUSCH is scrambled by at least one of the following:
a Cell-Radio Network Temporary Identifier (C-RNTI);
a Modulation and Coding Scheme Cell-Radio Network Temporary Identifier (MCS-C-RNTI); or
a Configured Scheduling Radio Network Temporary Identifier (CS-RNTI).

5. The method according to claim 1, wherein the terminal does not expect a resource that is indicated by the uplink muting pattern and on which transmission is not performed to overlap an RE in which a Phase Tracking Reference Signal (PTRS) of the PUSCH is located.

6. The method according to claim 1, wherein when an Uplink Control Information (UCI) is multiplexed and transmitted on the PUSCH, the resources that are indicated by the uplink muting pattern and on which transmission is not performed are skipped for UCI mapping.

7. The method according to claim 2, wherein the number of CSI reports for transmission comprises a number of second parts of the CSI reports for the transmission.

8. The method according to claim 1, wherein the transmission information comprises a Transport Block Size (TBS), and
wherein the determining transmission information of an uplink channel based on the number of first REs comprises:
calculating, based on the number of first REs, the number of second REs allocated to the PUSCH in a single Physical Resource Block (PRB), wherein the number of first REs is the number of REs that are associated with the uplink muting pattern and on which transmission is not performed in a single PRB; and
calculating a TBS of the PUSCH based on the number of second REs,
wherein the number of second REs is a value obtained by subtracting a first value from a first product, wherein:
the first product is a product of the number of subcarriers contained in a single PRB and the number of symbols of the PUSCH scheduled in a single slot; and
the first value is a sum of the following three values:
a configured overhead in a serving cell configuration corresponding to the PUSCH, the number of first REs, and the number of REs occupied by a DeModulation Reference Signal (DMRS) in a single PRB within an allocation period of the PUSCH; or
wherein the determining transmission information of an uplink channel based on the number of first REs comprises:
calculating the number of third REs allocated to the PUSCH in a single PRB;
calculating a total number of REs allocated to the PUSCH in a single slot based on the number of first REs, the number of third REs, and the number of PRBs allocated to the terminal, wherein the number of first REs is the number of REs that are associated with the uplink muting pattern and on which transmission is not performed in a PRB for transmitting the PUSCH; and
calculating a TBS of the PUSCH based on the total number of REs,
wherein the total number of REs is a value obtained by subtracting the number of first REs from a second product, and wherein:
the second product is a product of a minimum value and the number of PRBs allocated to the terminal, and the minimum value is a minimum value in the number of third REs and a preset threshold.

9. The method according to claim 1, wherein the transmission information comprises an effective channel code rate,
wherein when the effective channel code rate of the uplink channel is greater than a preset threshold, the terminal does not transmit the uplink channel, or the terminal does not expect the effective channel code rate of the uplink channel to be greater than the preset threshold.

10. A configuration information sending method, performed by a network-side device, comprising:
sending configuration information to a terminal, wherein the configuration information is used for configuring an uplink muting pattern, and the uplink muting pattern is used for indicating resources on which transmission is not performed.

11. The method according to claim 10, wherein the uplink muting pattern is applicable to at least one of the following:
a dynamically scheduled Physical Uplink Shared CHannel (PUSCH); or
a configured grant PUSCH.

12. The method according to claim 11, wherein a Cyclic Redundancy Check (CRC) in a Downlink Control Information (DCI) format of the dynamically scheduled PUSCH is scrambled by at least one of the following:
a Cell-Radio Network Temporary Identifier (C-RNTI);
a Modulation and Coding Scheme Cell-Radio Network Temporary Identifier (MCS-C-RNTI); or
a Configured Scheduling Radio Network Temporary Identifier (CS-RNTI).

13. The method according to claim 12, wherein a resource that is indicated by the uplink muting pattern and on which transmission is not performed does not overlap a Resource Element (RE) in which a Phase Tracking Reference Signal (PTRS) of a PUSCH is located.

14. The method according to claim 10, wherein the configuration information is higher-layer signaling configuration information.

15. A terminal, comprising:
a memory configured to store computer-readable instructions; and
a processor coupled to the memory and configured to execute the computer-readable instructions, wherein the computer-readable instructions, when executed by the processor, cause the processor to perform operations comprising:
obtaining configuration information, wherein the configuration information is used for configuring an uplink muting pattern, and the uplink muting pattern is used for indicating resources on which transmission is not performed; and
determining transmission information of an uplink channel based on a number of first Resource Elements (REs),
wherein the number of the first REs is the number of REs that are associated with the uplink muting pattern and on which transmission is not performed, and the uplink channel comprises:
a Physical Uplink Shared CHannel (PUSCH).

16. The terminal according to claim 15, wherein the transmission information comprises at least one of the following:
a transmission resource; or
a number of Channel State Information (CSI) reports for transmission.

17. The terminal according to claim 15, wherein the uplink muting pattern is applicable to at least one of the following:
a dynamically scheduled PUSCH; or
a configured grant PUSCH.

18. The terminal according to claim 17, wherein a Cyclic Redundancy Check (CRC) in a Downlink Control Information (DCI) format of the dynamically scheduled PUSCH is scrambled by at least one of the following:
a Cell-Radio Network Temporary Identifier (C-RNTI);
a Modulation and Coding Scheme Cell-Radio Network Temporary Identifier (MCS-C-RNTI); or
a Configured Scheduling Radio Network Temporary Identifier (CS-RNTI).

19. The terminal according to claim 15, wherein the terminal does not expect a resource that is indicated by the uplink muting pattern and on which transmission is not performed to overlap an RE in which a Phase Tracking Reference Signal (PTRS) of the PUSCH is located.

20. The terminal according to claim 15, wherein when an Uplink Control Information (UCI) is multiplexed and transmitted on the PUSCH, the resources that are indicated by the uplink muting pattern and on which transmission is not performed are skipped for UCI mapping.
